(19) United States
(12) Patent Application Publication
(10) Pub. No.: US 2023/0345564 A1
(43) Pub. Date: Oct. 26, 2023

(54) HANDLING USER PLANE DATA IN A RELAYING SCENARIO

(71) Applicant: Fraunhofer-Gesellschaft zur Förderung der angewandten Forschung e.V., München (DE)

(72) Inventors: Nithin SRINIVASAN, Berlin (DE); Baris GÖKTEPE, Berlin (DE); Roya EBRAHIM REZAGAH, Berlin (DE); Thomas FEHRENBACH, Berlin (DE); Cornelius HELLGE, Berlin (DE); Thomas WIRTH, Berlin (DE); Thomas SCHIERL, Berlin (DE)

(21) Appl. No.: 18/303,324

(22) Filed: Apr. 19, 2023

Related U.S. Application Data
(63) Continuation of application No. PCT/EP2021/077145, filed on Oct. 1, 2021.

(30) Foreign Application Priority Data
Oct. 20, 2020 (EP) 20202840.3

(51) Int. Cl. H04W 76/15; H04W 76/14

(52) U.S. Cl. CPC H04W 76/15; H04W 76/14; H04W 88/04

(57) ABSTRACT

A user device, UE, for a wireless communication network is described that acts as a relaying entity so as to provide functionality to support connectivity between one or more transmitting entities and one or more receiving entities of the wireless communication network. The UE is to sets up one or more logical channels and/or one or more data bearers for a transmission of data from the UE to the one or more receiving entities based on the origin of the data.

### CROSS-REFERENCE TO RELATED APPLICATIONS

This application is a continuation of copending International Application No. PCT/EP2021/077145, filed Oct. 1, 2021, which is incorporated herein by reference in its entirety, and additionally claims priority from European Application No. 20202840.3, filed Oct. 20, 2020, which is also incorporated herein by reference in its entirety.

### TECHNICAL FIELD

The present invention relates to the field of wireless communication systems or networks, more specifically to the field of relay devices or relay entities used to provide functionality to support connectivity between one or more transmitting entities and one or more receiving entities of the wireless communication system or network. Embodiments of the present invention relate to the handling of user plane data in a relaying scenario.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary Iot devices which connect to a base station or to a user. The mobile devices or the Iot devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two Iot devices 110₁ and 110₂ in cell 106₄, which may be stationary or mobile devices. The Iot device 110₁ accesses the wireless communication system via the base station gNB₄ to receive and transmit data as schematically represented by arrow 112₁. The Iot device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first UE 152 and a second UE 154 both in the coverage area 150 of the base station gNB. Both UEs 152, 154 are connected to the base station gNB and, in addition, they are connected directly with each other over the PC5 interface. The scheduling and/or interference management of the traffic, like a V2V traffic in case the UEs are respective vehicles, is assisted by the gNB via control signaling over the Uu interface, which is the radio interface between the base station and the UEs. In other words, the gNB provides SL resource allocation configuration or assistance for the UEs, and the gNB assigns the resources to be used for the D2D communication over the sidelink. In case of a vehicular communication, this configuration is also referred to as a mode 1 configuration in NR V2X or as a mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three UEs 156, 158 and 160 are shown directly communicating with each other over a sidelink, e.g., using the PC5 interface. The scheduling and/or interference management of the traffic is based on algorithms implemented between the UEs. In case of a vehicular communication, this configuration is also referred to as a mode 2 configuration in NR V2X or as a mode 4 configuration in LTE V2X. As mentioned above, the scenario in FIG. 2(b) which is the out-of-coverage scenario does not necessarily mean that the respective UEs are outside of the coverage 150 of a base station, rather, it means that the respective mode UEs are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the UEs 152, 154, like NR mode 1 or LTE mode 3 UEs, also the UEs 156, 158, 160, like NR mode 2 or LTE mode 4 UEs, are present.

In addition, FIG. 2(a), schematically illustrates an in-coverage UE using a relay UE to communicate with the network. For example, instead of a direct communication with the gNB over the Uu interface, the UE 152 may communicate over the sidelink with a relay UE 162 which, in turn, may be connected to the gNB via the Uu interface. Thus, the relay UE 162 may relay information between the gNB and the UE 162. In addition, FIG. 2(b), schematically illustrates an out of coverage UE using a relay UE to communicate with the network. For example, the UE 160 may communicate over the sidelink with relay UE 164 which, in turn, may be connected to the gNB via the Uu interface. Thus, UE 164 may relay information between the gNB and the UE 160.

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In a wireless communication system or network, like the one described above with reference to FIG. 1, relay devices or relay nodes may be employed to solve performance issues, like a reduced data rate, a weaker signal and higher interference as it may be encountered on the radio coverage edges of a cell of a base station. The relay node may extract data from a received signal, apply noise correction and retransmit a new signal on its own. Rather than only repeating the signal, the relay node also increases the signal quality. In the 3GPP specifications for 4G, a UE-to-Network relay has been specified.

It is noted that the information in the above section is only for enhancing the understanding of the background of the invention and, therefore, it may contain information that does not form known technology that is already known to a person of ordinary skill in the art.

Starting from the above, there may be a need for improvements or enhancements of relaying transmissions in a wireless communication system or network.

### SUMMARY

An embodiment may have a user device, UE, for a wireless communication network, wherein the UE is to act as a relaying entity so as to provide functionality to support connectivity between one or more transmitting entities and one or more receiving entities of the wireless communication network, wherein the UE is to set up one or more logical channels for a transmission of data from the UE to the one or more receiving entities based on the origin of the data.

Another embodiment may have a user device, UE, for a wireless communication network, wherein the UE is to act as a relaying entity so as to provide functionality to support connectivity between one or more transmitting entities and one or more receiving entities of the wireless communication network, wherein the UE is to set up a plurality of radio bearers for a transmission of data from the UE to the one or more receiving entities based on the origin of the data.

Another embodiment may have a radio access network, RAN, entity for a wireless communication network, wherein the RAN entity is to communicate with one or more user devices, UEs, of the wireless communication network via a relaying entity providing functionality to support connectivity between the RAN entity and the one or more UEs, wherein the relaying entity has an inventive user device, UE, as mentioned above.

According to another embodiment, a wireless communication network may have: one or more relaying entities having an inventive user device, UE, as mentioned above, one or more inventive RAN entities as mentioned above, and one or more remote user devices, UEs, the one or more remote UEs to communicate with a RAN entity via a relaying entity.

According to another embodiment, a method for operating a user device, UE, for a wireless communication network may have the steps of: providing, by the UE, functionality to support connectivity between one or more transmitting entities and one or more receiving entities of the wireless communication network, and setting up one or more logical channels for a transmission of data from the UE to the one or more receiving entities based on the origin of the data.

According to another embodiment, a method for operating a user device, UE, for a wireless communication network may have the steps of: providing, by the UE, functionality to support connectivity between one or more transmitting entities and one or more receiving entities of the wireless communication network, and setting up a plurality of radio bearers for a transmission of data from the UE to the one or more receiving entities based on the origin of the data.

According to another embodiment, a method for operating a radio access network, RAN, entity for a wireless communication network may have the step of: communicating with one or more user devices, UEs, of the wireless communication network via a relaying entity providing functionality to support connectivity between the RAN entity and the one or more UEs, wherein the relaying entity has an inventive user device, UE, as mentioned above.

Another embodiment may have a non-transitory digital storage medium having stored thereon a computer program for performing the above inventive methods when said computer program is run by a computer.

### BRIEF DESCRIPTION OF THE DRAWINGS

Embodiments of the present invention are now described in further detail with reference to the accompanying drawings, in which:

FIGS. 1(a)-1(b) are schematic representations of an example of a terrestrial wireless network, wherein FIG. 1(a) illustrates a core network and one or more radio access networks, and FIG. 1(b) is a schematic representation of an example of a radio access network RAN;

FIGS. 2(a)-2(b) schematically represent in-coverage and out-of-coverage scenarios, wherein FIG. 2(a) is a schematic representation of an in-coverage scenario in which two UEs directly communicating with each other are both connected to a base station, and FIG. 2(b) is a schematic representation of an out-of-coverage scenario in which the UEs directly communicating with each other,

FIGS. 3(a)-3(b) schematically illustrate several relaying scenarios, wherein FIG. 3(a) illustrates a scenario where a relay UE operates as a UE-to-Network relay, and FIG. 3(b) illustrates a scenario where the relay is a UE-to-UE relay;

FIGS. 4(a)-4(c) illustrate protocol stacks for certain UE-to-network relaying scenarios, wherein FIG. 4(a) illustrates the protocol stock for L2 relaying, and FIG. 4(b) illustrates the protocol stack for L3 relaying;

FIG. 5 illustrates MAC-layer procedures for an Uu interface;

FIGS. 6(a)-6(b) illustrate an example for BSR formats that may be employed by a UE when requesting resources for an uplink transmission, wherein a short format is shown in FIG. 6(a) and a long format is shown in FIG. 6(b);

FIGS. 7(a)-7(b) illustrate a normal or regular BSR send by a relay, as shown in FIG. 7(a), versus an early BSR concept as illustrated in FIG. 7(b);

FIG. 8 is a schematic representation of a wireless communication system including a transmitter, like a base station, one or more receivers, like user devices, UEs, and one or more relay UEs for implementing embodiments of the present invention;

FIG. 9 illustrates a user device, UE, in accordance with a first embodiment of the present invention;

FIG. 10 schematically illustrates a conventional relay UE performing conventional logical channel grouping based on channels having similar priorities;

FIGS. 11(a)-11(c) illustrate the logical channel grouping in accordance with an embodiment of the present invention;

FIG. 12(a)-12(c) illustrate the logical channel grouping in accordance with another embodiment of the present invention;

FIG. 13 illustrates the logical channel grouping in accordance with yet another embodiment of the present invention;

FIG. 14 illustrates an RRC configuration for a logical channel in accordance with an embodiment of the present invention;

FIG. 15 illustrates a user device, UE, in accordance with a second embodiment of the present invention;

FIG. 16 illustrates another conventional relay UE associating radio bearers with both remote UE data or traffic and relay UE data or traffic;

FIG. 17 illustrates an RRC configuration for a radio bearer in accordance with an embodiment of the present invention;

FIG. 18 illustrates an association of radio bearers in accordance with an embodiment of the present invention;

FIG. 19 illustrates an association of radio bearers in accordance with another embodiment of the present invention;

FIG. 20 illustrates an association of radio bearers in accordance with yet another embodiment of the present invention;

FIGS. 21(a)-21(d) illustrate embodiments for maintaining service continuity during path switching;

FIGS. 22(a)-22(c) show flowcharts of a trigger criterion for the BSR in accordance with embodiments of the present invention; and

FIG. 23 illustrates an example of a computer system on which units or modules as well as the steps of the methods described in accordance with the inventive approach may execute.

### DETAILED DESCRIPTION OF THE INVENTION

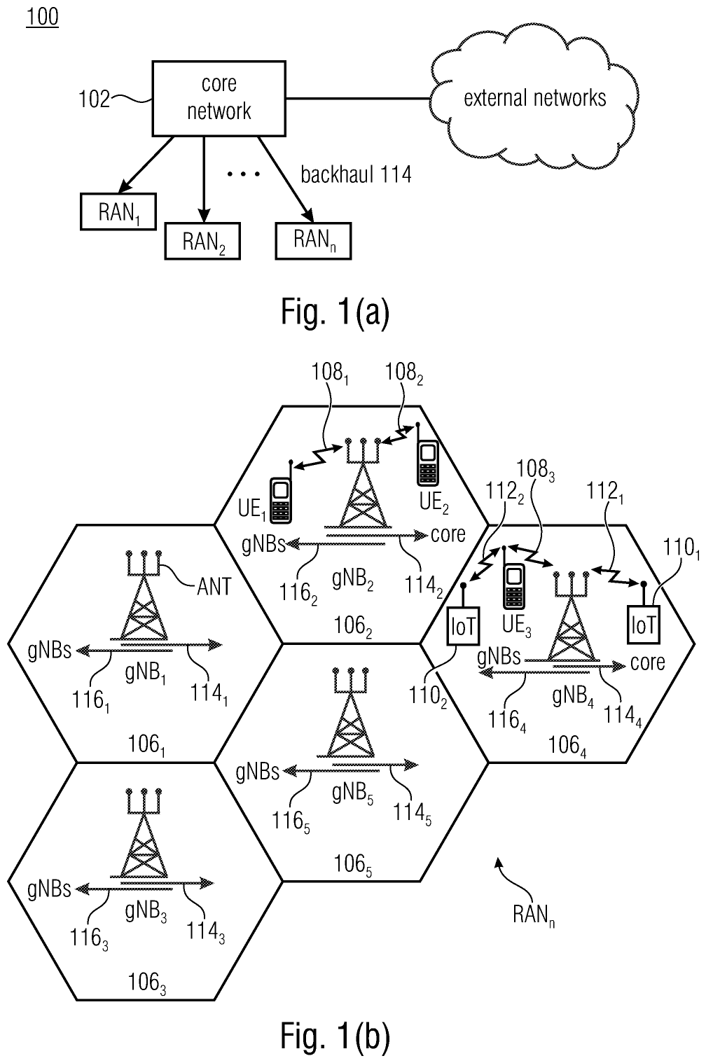

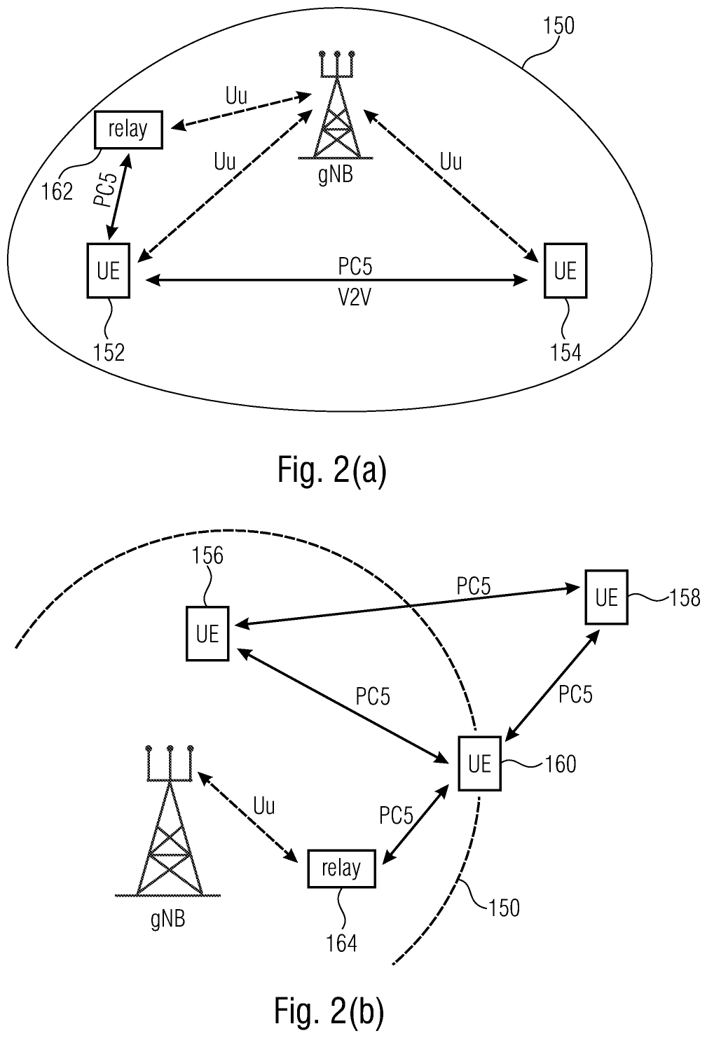

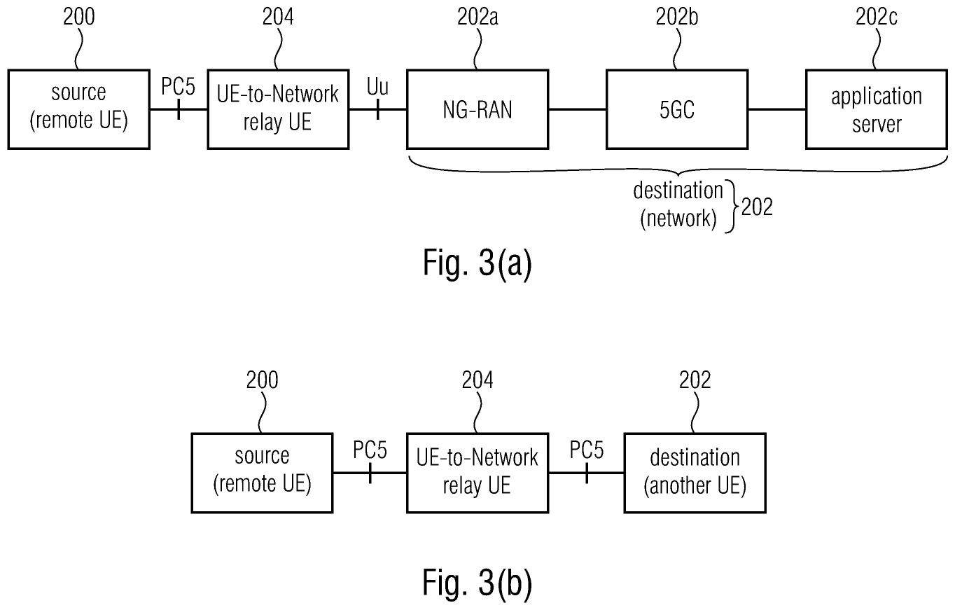

Embodiments of the present invention are now described in more detail with reference to the accompanying drawings, in which the same or similar elements have the same reference signs assigned. p In a wireless communication system or network, like the one described above with reference to FIG. 1, relay devices or relay nodes may be employed to extend the coverage of wireless networks or to solve performance issues, like a reduced data rate, a weaker signal and higher interference as it may be encountered on the radio coverage edges of a cell of a base station. The relay node may simply repeat and forward a received signal or transmission. In other examples, the relay node may extract data from a received signal or transmission, apply noise correction and send a new signal or a new transmission on its own. Rather than only repeating the signal, the relay node may also increases the signal quality. FIG. 3(a) illustrates a scenario where a relay UE operates as a UE-to-Network relay. The relay device or relay node mentioned above may be a user equipment, UE, and, in the following, is referred to a relay UE. FIG. 3(a) illustrates a UE 200 that is to connect to a destination 202, e.g., to an entity of the access network 202a, like a gNB, or to an entity of the core network 202b, or to an application server 202c. The end-to-end communication between the UE 200, which is also referred to as a transmitting entity, a source or a remote UE, and the destination 202, which is also referred to as a receiving entity, uses a relay UE 204 that provides functionality to support connectivity to the destination 202 for the remote UE 200. The remote UE 200 and the relay UE 204 may communicate using the PC5 interface, and the relay UE 204 and the access network 202a may communicate using the Uu interface.

In NR or 5G, in addition to the UE-to-Network relay, also a UE-to-UE relay is supported. In such a scenario, the destination 202 is another UE. FIG. 3(b) illustrates a scenario where the relay is a UE-to-UE relay 204. The remote UE 200 is to connect to the other UE 202, and the relay UE 204 provides functionality to support connectivity to the destination UE 202. The remote UE 200 and the relay UE may communicate using the PC5 interface, and the relay UE and the other UE 202 may communicate using also the PC5 interface.

Although FIG. 3(a) and FIG. 3(b) illustrate the relay to be a UE, it is noted that the relay may be any entity having network connectivity and enabling that the remote UE 200 is connected to the destination 202, like the core network or another UE. For example, the relay entity may be a group leader UE, a roadside unit, RSU, or any mobile or stationary device. Such a relay entity may be a relay node having some base station functionality, such as scheduling of resources, etc. Furthermore, a relay may also be a relay node in the classical sense, e.g. a base station infrastructure device, providing relaying functionality as in an amplify and forward (AF) relay, or a decode-and-forward relay (DF), e.g. operating on layer-2 (L2), or even a layer-3 (L3), which forwards data on Internet Protocol (IP)-level.

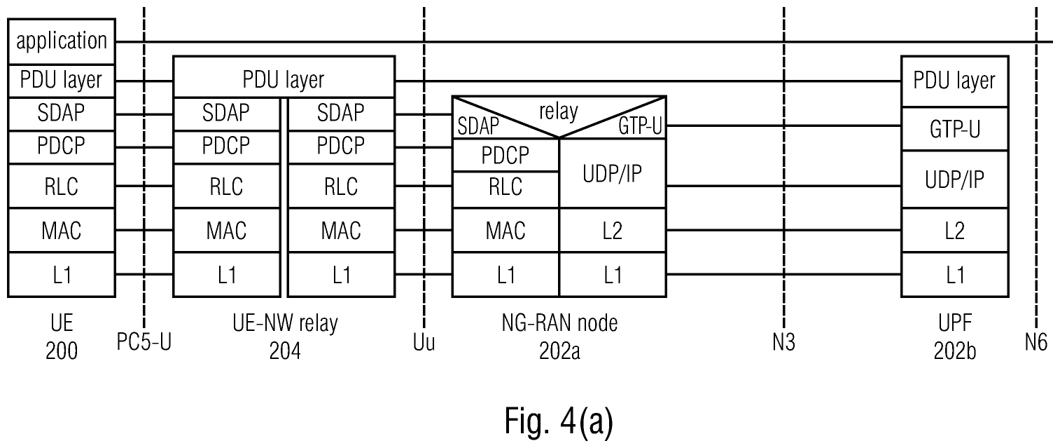

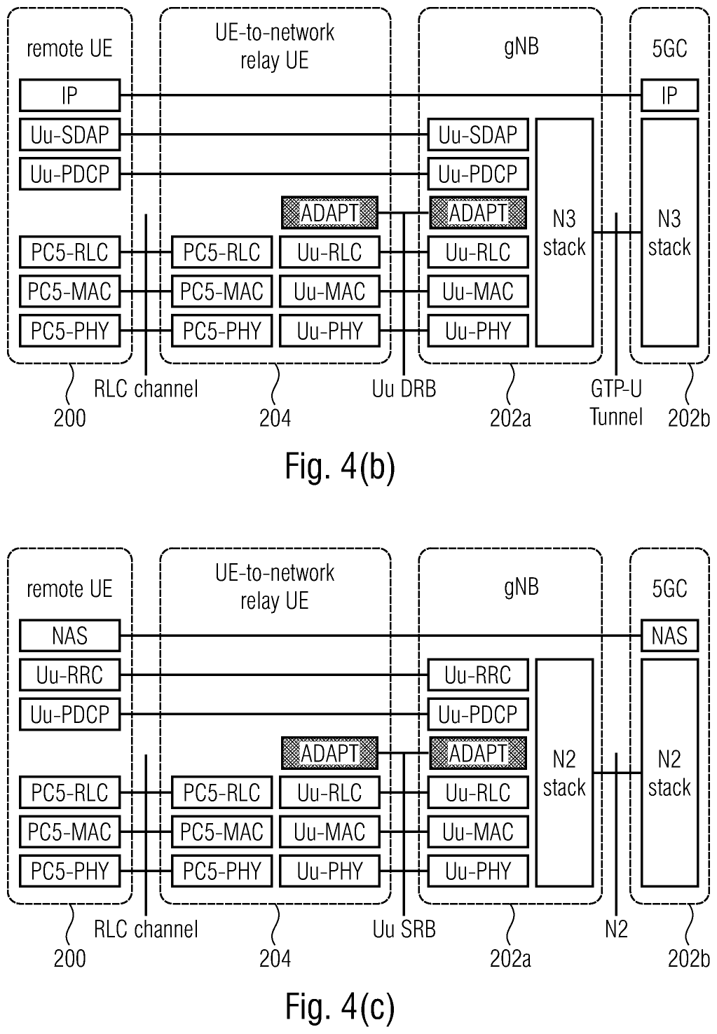

FIG. 4 illustrates the respective protocol stacks, wherein FIG. 4(a) illustrates the protocol stock for L3 relaying, and FIG. 4(b) and FIG. 4(c) illustrate the protocol stack for L2 relaying. In FIG. 4, UE-to-network scenarios are illustrated, in which the destination or receiving entity is a network entity 202b. As is illustrated, the remote UE 200 is connected via the PC5 interface to the L2 or L3 relay 204 which, in turn, is connected to the network, for example, to the radio access network 202a via the Uu interface. In L3 relaying the radio access network 202a is connected to the core network 202b via the N3 network, see FIG. 4(a), and all layers of the remote UE 200 terminate at each hop at the relay UE 204, thereby providing a structure for a hop-by-hop management of the system. In L2 relaying, see FIGS. 4(b) and FIG. 4(c), the radio access network 202a is connected to the core network 202b via the GPRS Tunnel Protocol, GPT-U, see FIG. 4(b), or via the N3 network, see FIG. 4(c), and the higher layers of the remote UE 200 terminate at the radio access network, RAN, 202a and at the core network, CN, 202b thereby providing a structure for an end-to-end management of the system.

When considering UE-2-network-relaying using the protocol stacks of FIG. 4, from the point of view of the radio access network, RAN, there is a principle difference in operation between L2 and L3 relaying. In L2 relaying, the remote UE 200 is visible to the RAN 202a because the higher layers of the remote UE protocol stack terminate at the RAN 202a, namely the packet data control protocol, PDCP, layer and the service data adaption protocol, SDAP, layer (see FIG. 4(b)) or the radio resource control, RRC, layer (see FIG. 4(c)). As a result, at the higher layers, like at the PDCP-layer, the RAN 202b may differentiate between data originating at the remote UE 200 and data originating at the relay 204. On the other hand, when applying L3 relaying, the remote UE 200 is invisible to the RAN 202b as the higher layers of the protocol stack are terminated hop-by-hop. As a result, even the higher layers of the protocol stack at the RAN 202a may not differentiate between data originating from the remote UE and data originating from the relay UE. Only in the core network 202b, like in the user plane function, UPF, of the 5G core network, 5CG, an identification of the remote UE 200 may be performed so as to allow forwarding the corresponding data to an appropriate application server 202c.

However, both in L2 relaying and in L3 relaying, as the media access control, MAC, layer terminates at each hop, from the perspective of MAC-layer scheduling, the RAN 202a needs to schedule a transmission over the Uu interface without knowing whether the data belongs or originates to the remote UE 200 or whether the data belongs or originates at the relay 204. When assuming that the remote UE 200 is connected to the relay UE 204 over the sidelink, like the PC5 interface, the RAN 202a is not able to apply any optimization, for example with regard to the scheduling or load balancing, between data originating at the relay UE 204 and data originating at the remote UE 200.

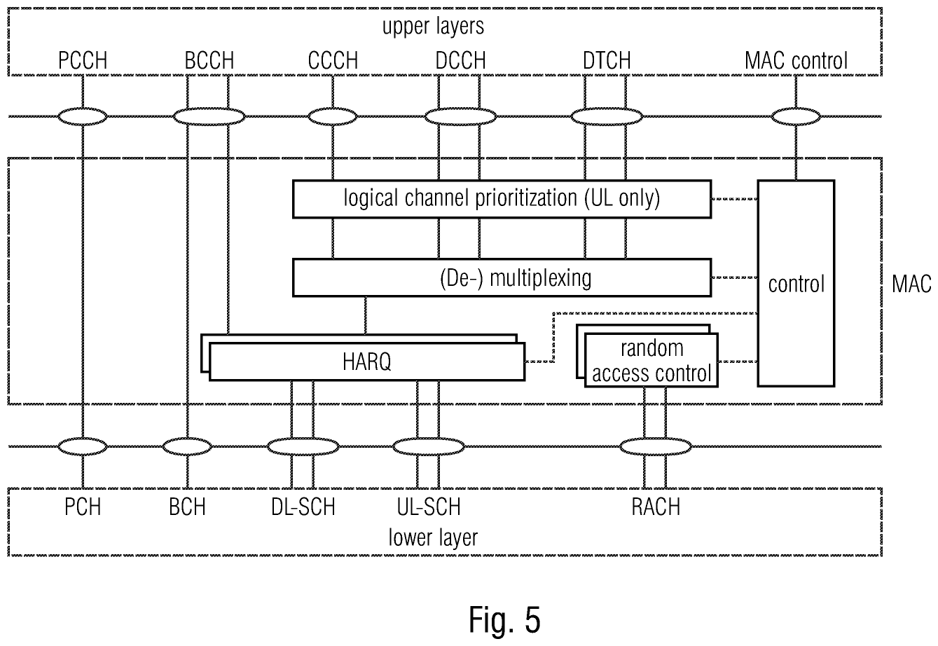

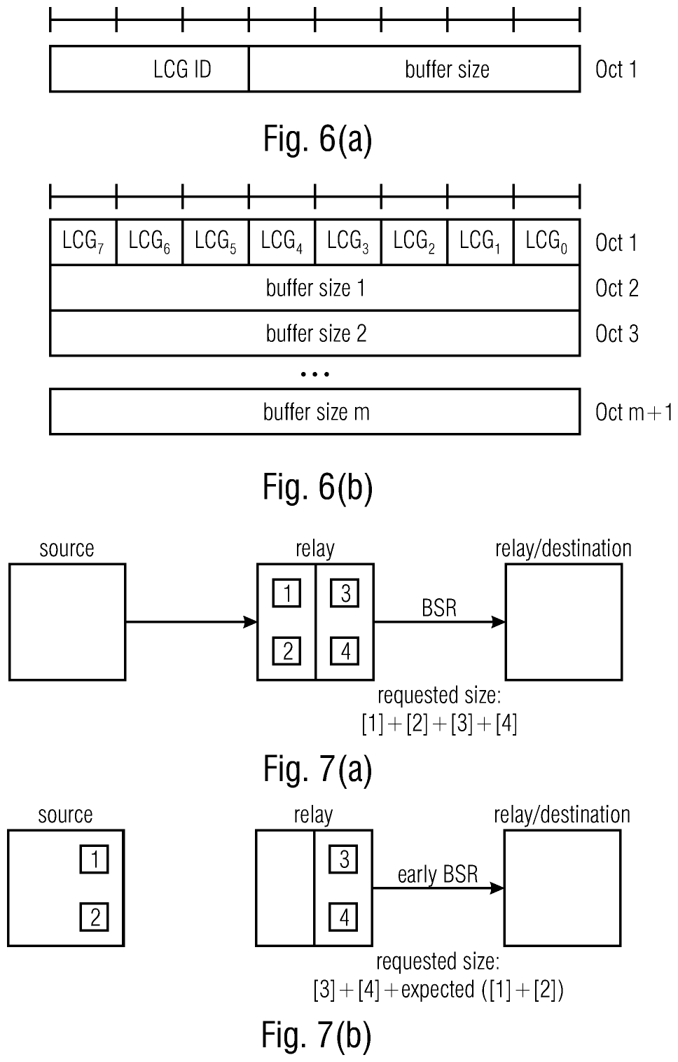

The MAC-layer procedures for the Uu interface are now described with reference to FIG. 5, which illustrates the lower layers including the paging channel, PCH, the broadcast channel, BCH, the downlink shared channel, DL-SCH, the uplink shared channel, UL-SCH, and the random access channel, RACH. The upper layers include the paging control channel, PCCH, the broadcast control channel, BCCH, the common control channel, CCCH, the dedicated control channel, DCCH, and the dedicated traffic channel, DTCH, as well as the MAC-control. The MAC-layer performs the logical channel prioritization, the multiplexing and de-multiplexing, handles the hybrid automatic repeat requests, HARQs, and the random access. For scheduling uplink, UL, user plane, UP, data over the Uu interface, as part of the protocol stack, PS, setup, a UE sets up logical channels at the MAC layer, and each of the logical channels is associated with a configuration. Some of the parameters in such a configuration may include the parameters priority, prioritizedBitRate and bucketsize. When data is available at one of the logical channels, the UE requests resources for the uplink transmission using a buffer status report, BSR, that may be triggered per logical channel. However, triggering the BSR for every logical channel creates undesired signaling overhead that may be avoided by grouping logical channels in such a way that the UE does not need to send a request per logical channel but instead the UE may request resources for a group of logical channels, thereby lowering the signaling overhead. FIG. 6 illustrates an example for the BSR formats that may be employed by the UE when requesting resources for the uplink transmission. The BSR may have a short format as shown in FIG. 6(a) or a long format as shown in FIG. 6(b). The BSR short format comprises one octet indicating at the beginning an identification of the logical channel group, LCG, and the associated buffer size. On the other hand, the BSR long format may request resources for a plurality of LCGs. The respective LCGs to which the BSR pertains are indicated in the first octet, while a plurality of further octets is provided each being associated with a certain buffer size associated with the respective LCGs indicated in the first octet.

The grouping of the logical channels may be done at the RAN based on priorities, i.e., logical channels having similar priorities may be grouped together into the above mentioned logical channel groups, LCGs, and the logical channel configuration may include a parameter called logicalChannelGroup. The logical channel prioritization, LCP, performs the scheduling of the different logical channels in the uplink for the grant received from the RAN. The LCP is based on certain rules and may schedule resources for each logical channel based on priority.

Another conventional concept is the so-called early buffer status report, early BSR. FIG. 7 illustrates a normal BSR, as shown in FIG. 7(a), versus the concept of an early BSR as illustrated in FIG. 7(b). In a normal BSR, a source, like a remote UE, may transmit packets 1 to 4 to the relay which, once the transmissions 1 to 4 are received at the relay, sends a BSR to the destination to request resources for sending the transmissions 1 to 4. When implementing the concept of an early buffer status report, the relay is aware that in addition to the already received transmissions 3 and 4, additional transmissions 1 and 2 are about to be transmitted by the source and, based on this knowledge, the relay triggers an early BSR requesting not only resources for sending transmissions 3 and 4, but also for sending the expected transmissions 1 and 2. Conventionally, in a context of an integrated access backhaul, IAB, the early BSR reporting is standardized to reduce the latency when requesting for resources for the relay node from the next hop or from the destination, like a base station, and the early BSR is triggered even before the data has arrived at the relay node from the source and is based on an expected amount of data the relay assumes to be receiving from the source.

As may be seen from the above discussion, in both L2 and L3 relaying, the MAC-layer terminates at each hop, so that, from the perspective of MAC-layer scheduling, the RAN 202a has no knowledge whether the data, for which the resources are requested, belong to the relay UE 204 itself, i.e., is data originating in the relay, or whether it is truly relayed data that belongs to the remote UE 200, i.e., is data originating at the remote UE. Since the RAN is not able to differentiate the data as being data originating from the relay or data originating from the remote UE, the RAN 202a is also unable to apply any optimizations in the scheduling process or to apply load balancing between data stemming from the relay or data stemming from the remote UE. For example, any data originating at the relay UE may be less important than data from a remote UE, and without knowledge of the origin of the data, the RAN does not consider any specific properties associated with a data transmission from the remote UE or from the relay UE so that data originating at the remote UE may not be handled in a way as desired. Another drawback of the lack of visibility at the RAN may be that the network is vulnerable to security or denial of service attacks, i.e., spurious transmissions from one or more so-called rogue remote UEs. A rogue remote UE is not authorized to enlist the services of the relay UE but does so to communicate with the network. In the process, the rogue remote UE may also prevent the relay UE data to be scheduled, i.e., preventing the relay UE from obtaining the required service. If RAN the is unaware of the origin of data, then it will always schedule the one or more remote UEs. However, if the RAN is made aware of the presence of the remote UEs and if specific information like the authorized remote UE list in the cell is given, e.g., by the core network, the RAN may reduce or even prevent such attacks.

The present invention addresses the above discussed drawbacks in conventional approaches and provides an approach for allowing an improved handling of data received from a relay UE so that, for example, the RAN is capable of handling data dependent on whether it originates at the remote UE or whether it originates at the relay UE.

Embodiments of the present invention provide an approach in accordance with which the relay UE no longer sets up the logical channels are according to a specific parameter associated with data or with a transmission, like a priority, rather the relay UE sets up the one or more logical channels in accordance with the origin of the data associated with the logical channels so that, for example, one or more logical channels at the relay UE are associated with data received at the relay UE from one or more remote UEs, also referred to as transmitting entities, while one or more other logical channels at the relay UE are associated with data from the relay UE itself, i.e., data originating at the relay. Thus, when requesting resources for such logical channels, the RAN is aware that the resources are requested for data that is to be relayed from a remote UE via the relay UE or for data that originates at the remote UE. In accordance with further embodiments, the above described channel grouping may be applied, and, for example, the logical control channels associated with data from the remote UEs, i.e., with data originating at the transmitting entities, may be grouped into one or more logical channel groups, LCGs, so that when requesting resources for such a logical channel group, the RAN is aware that the resources are requested for data that is to be relayed from a remote UE via the relay UE.

In accordance with other embodiments, the relay UE may set up a plurality of radio bearers based on the origin of the data. For example, some radio bearers may be associated with data originating at the transmitting entity, like the remote UE, while other data bearers may be associated with data originating at the relay UE so that the RAN may differentiate between the different types of traffic on the basis of the respective radio bearers associated with a certain type or origin of traffic, which may happen at the PDCP layer, e.g., in case of L3 relaying.

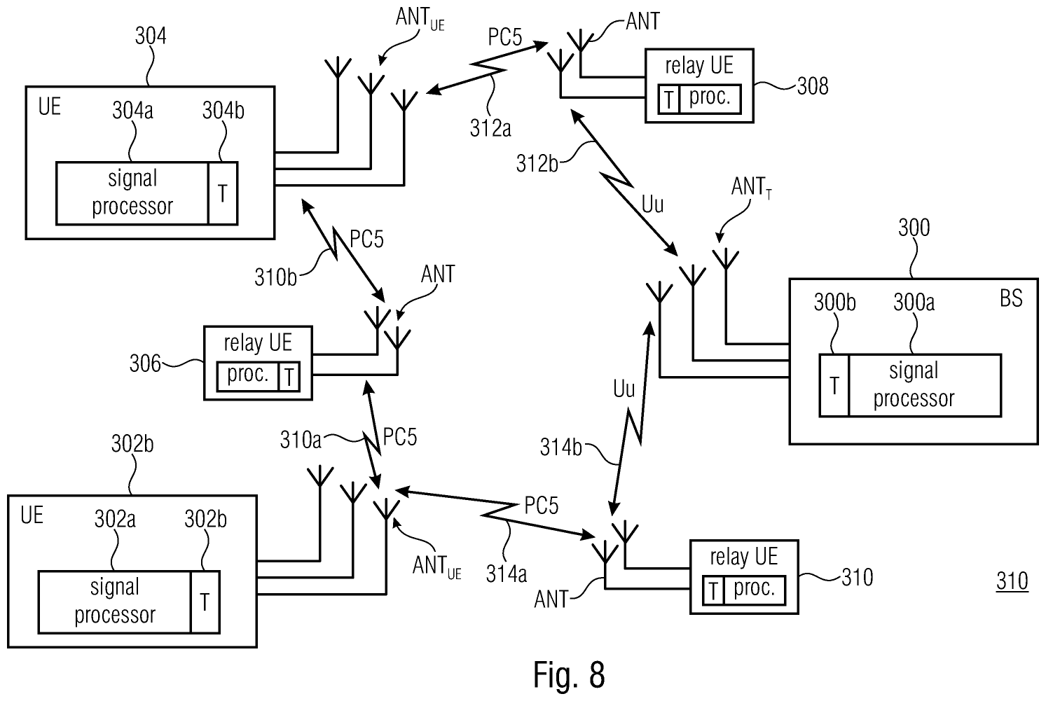

Embodiments of the present invention may be implemented in a wireless communication system as depicted in FIG. 1 including base stations and users, like mobile terminals or Iot devices. FIG. 8 is a schematic representation of a wireless communication system including a transmitter 300, like a base station or gNB, one or more user devices, UEs, 302, 304 and one or more relaying entities 306, 308 and 310, like relay UEs, for implementing embodiments of the present invention. The transmitter 300 and the receivers 302, 304 may communicate via the respective relaying entities 306, 308, 310 using respective wireless communication links or channels 310a, 310b, 312a, 312b and 314a, 314b, like respective radio links. The transmitter 300 may include one or more antennas ANTT or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. Each of the relaying entities 306, 308, 310 includes one or more antennas ANT or an antenna array having a plurality of antennas, a signal processor, and a transceiver T coupled with each other. The base station 300 and the UE 302 may communicate via the relaying entity 310 using the wireless communication link 314b, like a radio link using the Uu interface or another 3GPP or non-3GPP interface, between the base station 300 and the relaying entity 310, and using the wireless communication link 314a, like a radio link using the PC5/sidelink, SL, interface, between the UE 302 and the relaying entity 310. Likewise, the base station 300 and the UE 304 may communicate via the relaying entity 308 using the wireless communication link 312b, like a radio link using the Uu interface, between the base station 300 and the relaying entity 308, and using the wireless communication link 312a, like a radio link using the SL interface, between the UE 304 and the relaying entity 308. The UEs 302, 304 may communicate with each other via the relaying entity 306 using the wireless communication link 310a, like a radio link using the SL interface, between the UE 302 and the relaying entity 306, and using the wireless communication link 310b, like a radio link using the SL interface, between the UE 304 and the relaying entity 310. Any one of the system or network, the one or more UEs 302, 304, the one or more relaying entities 306-310 and/or the base station 300, as illustrated in FIG. 8, may operate in accordance with the inventive teachings described herein. In the following description, the relaying entity is referred to as relay UE.

### Relay UE Setting Up Logical Channels

The present invention provides a user device, UE, for a wireless communication network,
wherein the UE is to act as a relaying entity so as to provide functionality to support connectivity between one or more transmitting entities and one or more receiving entities of the wireless communication network,

wherein the UE is to set up one or more logical channels for a transmission of data from the UE to the one or more receiving entities based on the origin of the data.

In accordance with embodiments, the UE is to setup a plurality of logical channels for the transmission of data based on the origin of the data, and to group the plurality of logical channels into one or more groups of logical channels, LCGs.

In accordance with embodiments, the UE is to associate the at least one logical channel with data originating at the one or more transmitting entities.

In accordance with embodiments, the UE is to set up at least one further logical channel, and to associate at least one further logical channel with data originating at the UE.

In accordance with embodiments, the UE is to setup a plurality of further logical channels associated with data originating at the UE, and to group the plurality of further logical channels into one or more groups of logical channels, LCGs.

In accordance with embodiments,
the UE is configured or preconfigured with certain logical channels of the plurality of logical channels and with certain radio bearers, like SRBs and/or DRBs, of a plurality of radio bearers that are associated with relaying data from the UE to the one or more receiving entities, and
the UE is to map data originating at the one or more transmitting entities to the certain logical channels and to the certain radio bearers.

### Relay UE Setting Up Radio Bearers

The present invention provides a user device, UE, for a wireless communication network,
wherein the UE is to act as a relaying entity so as to provide functionality to support connectivity between one or more transmitting entities and one or more receiving entities of the wireless communication network,
wherein the UE is to set up a plurality of radio bearers for a transmission of data from the UE to the one or more receiving entities based on the origin of the data.

In accordance with embodiments, the UE is to set up the plurality of radio bearers such that one or more of the radio bearers, like SRBs and/or DRBs, are associated with data from the one or more transmitting entities.

In accordance with embodiments, the UE is to set up the plurality of radio bearers such that one or more others of the radio bearers are associated with data originating at the UE.

In accordance with embodiments,
one or more first signal bearers associated with one or more transmitting entities are to serve traffic classified to fulfill a first requirement, like a Guaranteed Bit Rate, GBR, and
one or more second signal bearers associated with one or more transmitting entities are to serve traffic classified to fulfill a second requirement, like a non-Guaranteed Bit Rate, non-GBR.

In accordance with embodiments, the one or more radio bearers associated with relaying allow the UE to provide a delivery status, e.g., at the PDCP layer.

In accordance with embodiments, responsive to a delivery status request, the UE is to poll one, some or all of the transmitting entities associated with a radio bearer associated with relaying so as to obtain
information about an impending uplink transmission of data at the one or more transmitting entities, and/or
a confirmation of an amount of data successfully received at the one or more transmitting entities.

In accordance with embodiments, the UE is to associate a radio bearer with a specific UE or with a combined set of UEs using an identification received via a receiving entity, like a RAN entity.

In accordance with embodiments, responsive to receiving the identifications, the UE is to associate a particular PDU session supported by the radio bearer with the corresponding Quality of Service, QoS, profile or link ID or service type for the one or more transmitting entities.

In accordance with embodiments, when a transmitting entity switches a path to a RAN entity from the UE to another relaying UE, the UE is to forward PDCP information, like a PDCP sequence number, SN, along with an identification of the transmitting entity the UE serves to the RAN entity, the PDCP information indicating to the RAN entity which data packets the RAN entity is expected to receive or send via the other relaying UE.

### Relay UE Setting Up Logical Channels and/or Radio Bearers

In accordance with embodiments, data originating at the one or more transmitting entities comprises
data originating at one of the transmitting entities, or
data originating at a plurality of the transmitting entities.

In accordance with embodiments, the one or more transmitting entities are in-coverage or out-of-coverage.

In accordance with embodiments, the UE is
configured with the association of the one or more logical channels and/or the one or more LCGs and/or the radio bearers with the origin of the data, e.g., using an RRC configuration explicitly indicating which LCG and/or radio bearer is associated with data originating at the transmitting entities, and which LCG and/or radio bearer is not associated with data originating at the transmitting entities, or
preconfigured, for example specified in the standards or embedded into the UE, with the association of the one or more logical channels and/or the one or more LCGs and/or the radio bearers with the origin of the data, e.g., such that one or more LCGs and/or one or more radio bearers are associated with data originating at the transmitting entities responsive to activating the relaying functionality at the UE.

In accordance with embodiments, the UE is to signal, e.g., using RRC signaling, which logical channel and/or which LCG and/or radio bearer is associated with data originating at the transmitting entities, and which LCG or radio bearer is not associated with data originating at the transmitting entities.

In accordance with embodiments, the UE is to explicitly indicate the one or more transmitting entities bundled into a logical channel and/or into an LCG and/or into a radio bearer.

In accordance with embodiments, when data is available at one or more of the logical channels, the UE is to request resources for the transmission from the UE to the one or more receiving entities, e.g., using a buffer status report, BSR, that may be triggered per logical channel or per LCG.

In accordance with embodiments, the UE is to trigger a BSR responsive to an amount of data originating at the transmitting entities reaching or exceeding a threshold, like a size or a certain percentage of the size of a transmission buffer of the UE.

In accordance with embodiments, the UE is to buffer data originating at the transmitting entities, e.g., in the transmission buffer at the RLC-layer/PDCP-layer or at the adaptation-layer, when the amount of data is below the threshold.

In accordance with embodiments, the UE is configured or preconfigured with one or more or all of the logical channels and/or one or more or all of the LCGs and/or one or more or all of the radio bearers being associated with an early BSR mechanism, and wherein the UE is to trigger the early BSR when data is associated with the one or more logical channels and/or the one or more logical channels grouped into the LCG and/or with the radio bearers.

In accordance with embodiments, the UE to map data originating at the transmitting entities and being associated with one or more special requirements, like low latency and/or high reliability, to a logical channel and/or to a LCG and/or to a radio bearer associated with the one or more special requirements.

In accordance with embodiments, the UE is configured or preconfigured with
a priority for each of the logical channels and/or radio bearers, and
a prioritization procedure, like a logical channel prioritization, LCP, procedure, to cause the UE to
   initially perform scheduling resources for data originating at the one or more transmitting UEs, followed by scheduling resources for data originating at the relaying entity, or
   initially perform scheduling resources for data originating at the relaying entity, followed by scheduling resources for data originating at the one or more transmitting UEs.

In accordance with embodiments,
the data comprises user-plane, UP, data, and the set up logical channels comprise dedicated traffic channels, DTCHs, and/or
the data comprises control-plane, CP, data, and the set up logical channels comprise dedicated control channels, DCCHs, common control channels, CCCHs.

In accordance with embodiments, the transmitting entity and the receiving entity comprises any one of a user device, UE, a relaying entity and a network entity, like a radio access network, RAN, entity.

In accordance with embodiments, a user device comprises one or more of the following: a mobile terminal, or a stationary terminal, or a cellular IoT-UE, or a vehicular UE, or a group leader (GL) UE, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### RAN Entity

The present invention provides a radio access network, RAN, entity for a wireless communication network,
wherein the RAN entity is to communicate with one or more user devices, UEs, of the wireless communication network via a relaying entity providing functionality to support connectivity between the RAN entity and the one or more UEs,
wherein the relaying entity comprises a user device, UE, according to the present invention.

In accordance with embodiments, the RAN entity is to configure a user device of the wireless communication network as the relaying entity such that one or more logical channels and/or one or more LCGs and/or one or more radio bearers are associated with the origin of the data, e.g., using an RRC configuration explicitly indicating which logical channel and/or LCG and/or radio bearer is associated with data originating at one or more further UEs using the relaying entity, and which logical channel and/or LCG and/or radio bearer is not associated with data originating at one or more further UEs using the relaying entity.

In accordance with embodiments,
the relaying entity is configured or preconfigured with certain logical channels of the plurality of logical channels and/or with certain radio bearers, like SRBs and/or DRBs, of a plurality of radio bearers that are associated with relaying data from the relaying entity to the RAN entity, and
the RAN entity is to send a delivery status request to the relaying entity, the delivery status request causing the relaying entity to poll one, some or all of the UEs associated with a certain radio bearer so as to obtain
   information about an impending uplink transmission of data at the one or more transmitting entities, and/or
   a confirmation of an amount of data successfully received at the one or more transmitting entities.

In accordance with embodiments, the RAN entity is to
receive an identification of the one or more UEs, like respective UE IDs, served by the relaying entity, and
associate a logical channel and/or a LCG and/or a radio bearer with a specific UE or with a combined set of UEs using the received identifications.

In accordance with embodiments, the RAN entity is to receive from the relaying entity, e.g., using RRC signaling, a signaling indicating which logical channel and/or which LCG and/or which radio bearer is associated with data originating at the transmitting UEs, and which logical channel and/or which LCG and/or which radio bearer is not associated with data originating at the transmitting UEs.

In accordance with embodiments, the signaling explicitly indicates the one or more transmitting UEs bundled into a logical channel and/or into an LCG and/or into a radio bearer.

In accordance with embodiments,
the RAN entity is to perform resource allocation or management using the received identifications, and/or
responsive to receiving the identifications, the RAN entity is aware of the UEs being served by a particular PDU session via the relaying entity, and a Quality of Service, QoS, profile or link ID or service type for the UEs.

In accordance with embodiments,
the RAN entity is to configure each of the logical channels and/or radio bearers at the relaying entity with a priority, and
the RAN entity is to configure a prioritization procedure, like a logical channel prioritization, LCP, procedure to
   initially perform scheduling resources for data originating at the one or more transmitting UEs, followed by scheduling resources for data originating at the relaying entity, or
   initially perform scheduling resources for data originating at the relaying entity, followed by scheduling resources for data originating at the one or more transmitting UEs.

In accordance with embodiments, the RAN entity comprises one or more of the following: a macro cell base station, or a small cell base station, or a central unit of a base station, or a distributed unit of a base station, or a road side unit (RSU), or a remote radio head, or any transmission/reception point, TRP, enabling an item or a device to communicate using the wireless communication network, the item or device being provided with network connectivity to communicate using the wireless communication network.

### Network

The present invention provides a wireless communication network, comprising
one or more relaying entities comprising a user device, UE, according to the present invention,
one or more RAN entities according to the present invention, and
one or more remote user devices, UEs, the one or more remote UEs to communicate with a RAN entity via a relaying entity.

In accordance with embodiments, when a remote UE switches a path to a RAN entity from a first relaying entity to a second relaying entity, the first relaying entity forwards PDCP information, like a PDCP sequence number, SN, along with a remote UE ID that the first relaying entity serves to the RAN entity, the PDCP information indicating to the RAN entity which data packets the RAN entity is expected to receive or send via the second relaying entity.

In accordance with embodiments, the first relaying entity and the second relaying entity are connected to the same RAN entity.

In accordance with embodiments, the first relaying entity is connected to a first RAN entity, and the second relaying entity is connected to a second RAN entity different from the first RAN entity, wherein the first relaying entity forwards the PDCP information the first RAN entity, and wherein the first RAN entity forwards the PDCP information received from the first relaying entity to the second RAN entity.

In accordance with embodiments, the RAN entity to which the second relaying entity is connected is to forward the PDCP information from the first relaying entity to the second relaying entity.

### Methods

The present invention provides a method for operating a user device, UE, for a wireless communication network, the method comprising:
providing, by the UE, functionality to support connectivity between one or more transmitting entities and one or more receiving entities of the wireless communication network, and
setting up one or more logical channels for a transmission of data from the UE to the one or more receiving entities based on the origin of the data.

The present invention provides a method for operating a user device, UE, for a wireless communication network, the method comprising:
providing, by the UE, functionality to support connectivity between one or more transmitting entities and one or more receiving entities of the wireless communication network, and
setting up a plurality of radio bearers for a transmission of data from the UE to the one or more receiving entities based on the origin of the data.

The present invention provides a method for operating a radio access network, RAN, entity for a wireless communication network, the method comprising:
communicating with one or more user devices, UEs, of the wireless communication network via a relaying entity providing functionality to support connectivity between the RAN entity and the one or more UEs,
wherein the relaying entity comprises a user device, UE, according to the present invention.

### Computer Program Product

Embodiments of the first aspect of the present invention provide a computer program product comprising instructions which, when the program is executed by a computer, causes the computer to carry out one or more methods in accordance with the present invention.

Embodiments of the present invention are now described in more detail and in the following description the terms remote UE data or remote UE traffic is used meaning data or traffic originating at the remote UE and successfully received at the relay UE and waiting to be transmitted to the radio access network. Also the term relay UE traffic or relay UE data is used meaning data or traffic originating at the UE, i.e., meaning the relay UE's own data or traffic that is waiting to be transmitted to the RAN. Embodiments of the present invention allow for optimizations in the scheduling on the Uu interface between remote UE data and relay UE data. Thus, embodiments are now described for an uplink, UL, scenario for transmitting data originating at a remote UE and/or at the relay UE to the RAN. Naturally, the transmitting entity and/or the receiving entity may also be another relay. Also, it is noted that the subsequently described embodiments are equally applicable for a downlink, DL, scenario for transmitting data originating at the RAN or at the relay UE to a remote UE, i.e., a transmitting entity may also by a RAN entity, like a gNB, or another relay, and a receiving entity may be a remote UE or another UE.

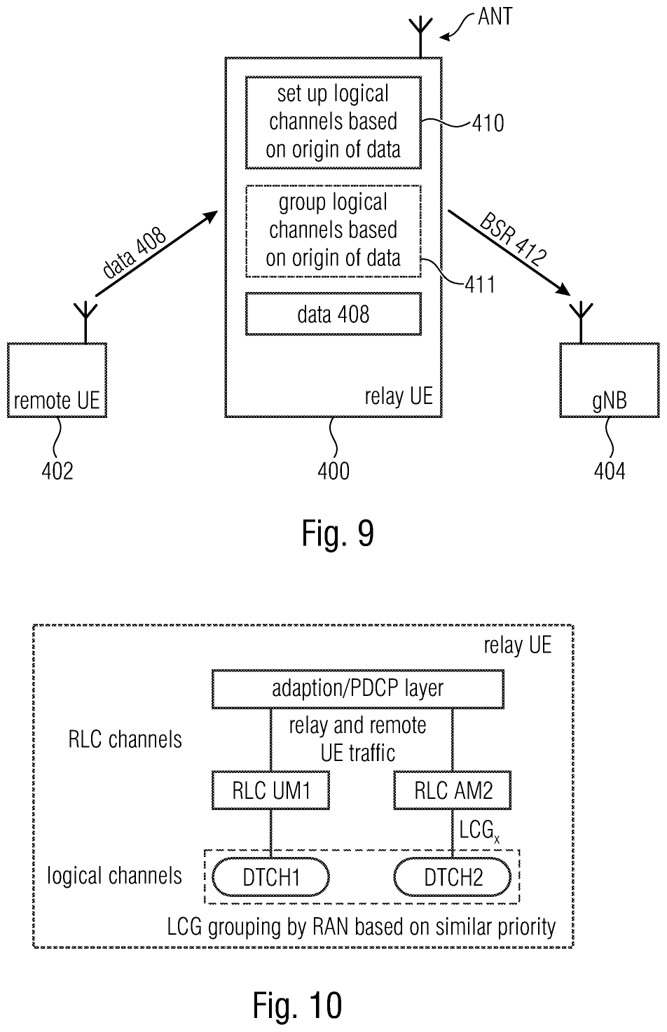

In accordance a first embodiment of the present invention, one or more logical channels are configured or set up at the relay UE in such a way that the RAN is able to differentiate the scheduling request between remote UE data and relay UE data, for example when the relay UE initiates a BSR. In other words, in accordance with the first embodiment of the present invention, the logical channels may be set up based on the origin of the data or the traffic. FIG. 9 illustrates a user device, UE, 400 that may be employed, for example, in a wireless communication network as described above with reference to FIG. 1. The user device, UE, 400 acts as a relaying entity so as to provide functionality to support connectivity between one or more transmitting entities, like one or more remote UEs 402 and one or more receiving entities 404 of the wireless communication network, like one or more base stations or gNBs. For the transmission of data from the relay UE 400 to the one or more transmitting entities 404, the relay UE 400 sets up one or more logical channels based on the origin of the data. In the embodiment depicted in FIG. 9, the relay UE 400 receives data 406 from the remote UE 402, also referred to in the following as data originating at the remote UE 402 or as remote UE data or remote UE traffic. The remote UE data 406 is to be forwarded to the receiving entity 404 via the relay UE 400. In addition, the relay UE may also have its own data 408 that needs to be transmitted to the receiving entity 404, also referred to in the following also as data originating at the relay UE or as relay UE data or relay UE traffic. As is indicated at 410, the relay UE 400 sets up the logical channels based on the origin of the data so that one or more logical channels are associated with remote UE data 406 while others, in accordance with embodiments, may be associated with the relay UE data 408. For the transmission to be performed by the relay UE 400, the relay UE issues a scheduling request, for example a buffer status report 412 that is transmitted to the receiving entity 404. The gNB 4040 performs the scheduling of resources for the transmission from the relay UE 400 to the gNB 404. Since the BSR 412 indicates certain logical channels associated with remote UE data 406, the gNB 404 is now able to differentiate between the remote UE data 406 and the relay UE data 408 when performing the scheduling.

In accordance with embodiments, when the relay UE 400 sets up a plurality of logical channels, it may also group the plurality of logical channels into one or more logical channel groups, LCGs, thereby grouping of the logical channels based on the origin of the data. As is indicated at 411, the relay UE 400 groups the logical channels based on the origin of the data so that one or more logical channels are grouped into a LCG associated with remote UE data 406 while others, in accordance with embodiments, may be grouped, if desired, into LCGs associated with the relay UE data 408. For the transmission to be performed by the relay UE 400, the relay UE issues a scheduling request, for example a buffer status report 412 that is transmitted to the receiving entity 404. The gNB 4040 performs the scheduling of resources for the transmission from the relay UE 400 to the gNB 404. Since the BSR 412 indicates certain logical channel groups associated with remote UE data, the gNB 404 is now able to differentiate between the remote UE data 406 and the relay UE data 408 when performing the scheduling.

In the following, embodiments of setting up, establishing or configuring the logical channel based on the origin of the traffic are described with reference to the layer 2, L2, relaying. In accordance with such embodiments, establishing the logical channels based on the origin of the traffic, i.e., whether the traffic or data is relay UE data or traffic or remote UE data or traffic, may be done on the basis of a signaling from the radio access network, RAN, for example, from the gNB 404. The RAN may decide which logical channels are associated with relaying. Other than in conventional approaches, where the grouping depends on channels having similar priorities, in accordance with embodiments of the present invention, the mechanism for setting up the logical channels is based on origin of the traffic so that, for example, logical channels with different priorities may be grouped together. This allows the RAN to address relay UE data or traffic and remote UE data or traffic separately. In accordance with embodiments, each logical channel may be associated with remote data or traffic from only one remote UE, while in accordance with other embodiments, a logical channel may be associated with or carry data or traffic from more than one remote UEs, like a UE group.

FIG. 10 schematically illustrates a conventional relay UE conventionally setting up logical channels associated with certain priorities and performing conventional logical channel grouping based on the setup channels having similar priorities. In FIG. 10, a relay UE is assumed having two channels including the radio link control, RLC, channels and the logical channels. The RLC channels include the RLC unacknowledged mode channel RLC UM 1 and the RLC acknowledge mode channel RLC AM 2. The logical channels include the dedicated traffic channel DTCH 1 and the dedicated traffic channel DTCH 2. As is indicated in FIG. 10, the RLC channels RLC UM 1 and RLC AM 2 are both associated with relay UE data or traffic and remote UE data or traffic, i.e., any data available at the relay UE is associated with the RLC channels without any differentiation about the origin of the data or traffic. In accordance with the conventional approach, the logical channels DTCH 1 and DTCH 2 are grouped into a logical channel group LCGₓ based on a similar priority of the data or traffic included in the respective RLC channels.

The conventional relay UE in FIG. 10 may request resources for the uplink transmission of the relay and remote UE traffic or data by sending a buffer status report, BSR, like a BSR explained above with reference to FIG. 6. When receiving a BSR, as explained above, the receiving entity, like a gNB, is not in a position to differentiate the traffic between relay UE traffic and remote UE traffic, rather, the gNB 404 only sees traffic coming from the relay UE.

The present invention, avoids any problems or drawbacks associated with such a conventional approach. Rather than setting up the respective channels based on priorities, according to embodiments the relay UE sets up the channels dependent on the origin of the traffic, i.e., whether the traffic comes from or origins at the remote UE or origins at the relay UE.

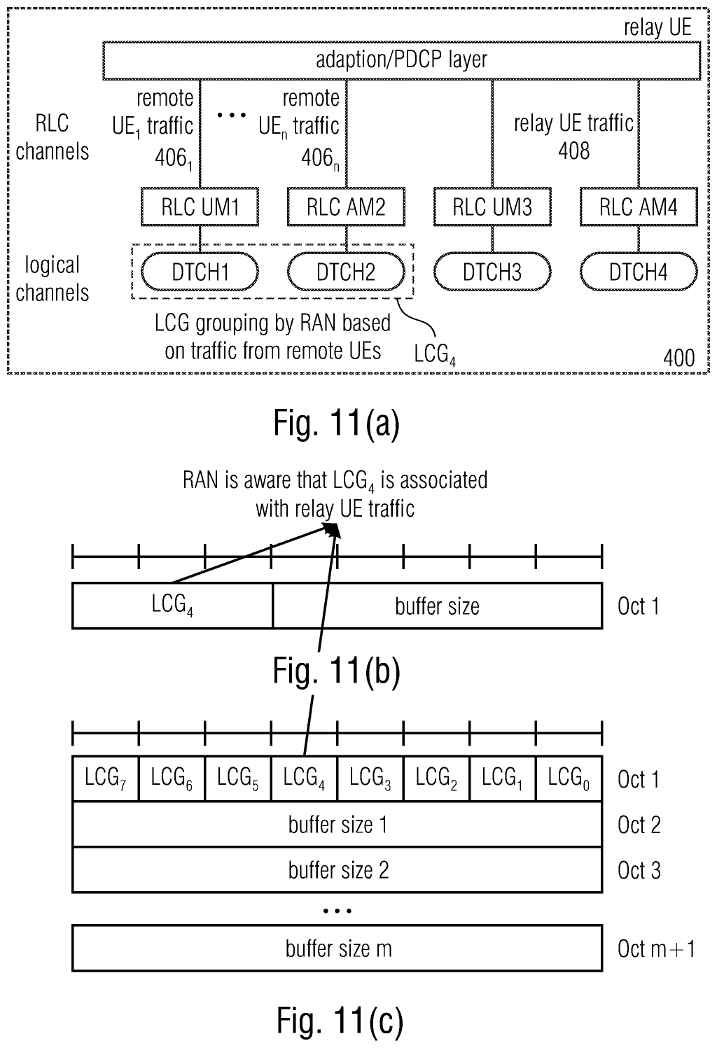

FIG. 11 illustrates the logical channel setup in accordance with an embodiment of the present invention, more specifically, FIG. 11(a) illustrates a relay UE 400 setting up or establishing the logical channels based on whether the originating traffic is from the remote UE or from the relay UE 400, FIG. 11(b) shows a short format BSR that may be used by the relay UE 400 to request resources for the transmission from the relay UE 400 to the receiving entity, like the gNB, and FIG. 11(c) illustrates a long format BSR. In FIG. 11, the relay UE 400 is assumed to be configured with four channels including RLC channels, RLC UM 1, RLC AM 2, RLC UM 3, RLC AM 4 and dedicated traffic channel DTCH 1, DTCH 2, DTCH 3, DTCH 4. In accordance with the inventive approach, the UE 400 sets up the logical channels such that each of the logical channels is associated with traffic originating either at a single remote UE or with traffic originating at the relay UE 400. More specifically, logical channels DTCH 1 and DTCH 2 are each associated with traffic from a single remote UE, while logical channels DTCH 3 and DTCH 4 are associated with traffic originating at the relay UE 400.

In accordance with embodiments, the logical channels associated with data or traffic from a remote UE, namely DTCH 1 and DTCH 2, are grouped into a logical channel group LCG₄, while the other logical channels DTCH 3 and DTCH 4 are not grouped. In accordance with other embodiments, also the logical channels DTCH 3 and DTCH 4 associated with relay UE traffic may be grouped into one or more logical channel groups. FIG. 11(b) and FIG. 11(c) illustrate a BSR in accordance with embodiments of the present invention which indicates in the first octet of each format the logical channel group LCG₄ that has been configured by the RAN to be an LCG associated with remote UE traffic. By including the indication of LCG₄ into the BSR the RAN knows that the requested resources are for a transmission of data originating the remote UE, i.e., the RAN is aware that the LCG₄ is associated with remote UE traffic.

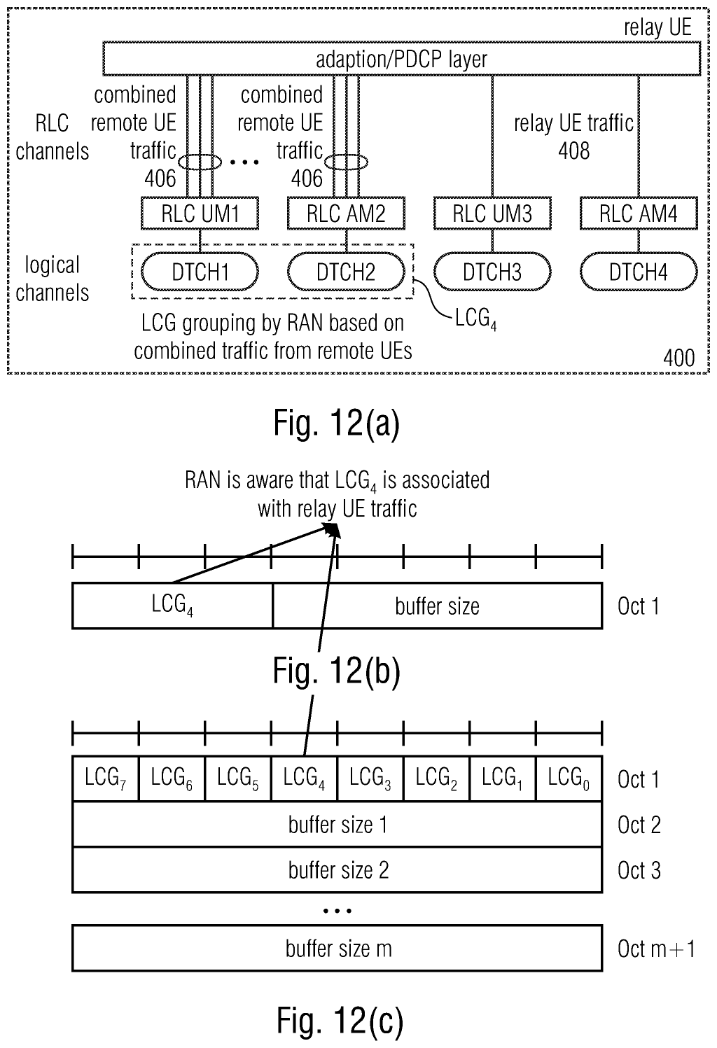

In accordance with further embodiments, a logical channel may be associated with traffic for more than one remote UE, and FIG. 12 illustrates an embodiment for a logical channel grouping combining traffic from multiple remote UEs into one logical channel. FIG. 12(a) schematically illustrates the relay UE 400, and FIG. 12(b) and FIG. 12(c) illustrate the short format and long format BSRs used by the relay UE 400 for requesting resources from a gNB. FIG. 12 is similar to FIG. 11 except that the RLLC channels RLC UM 1 and RLC AM 2 each are associated with traffic from more than one remote UE, referred to in the figure as combined remote UE traffic 406. In accordance with further embodiments, the logical channels DTCH 1 and DTCH 1 that are associated with combined remote UE traffic may be grouped by the RAN configuration into the logical channel group LCG₄. By indicating in the BSR the LCG₄, as is indicated in FIG. 12(b) and in FIG. 12(c), the RAN is aware that the LCG₄ is associated with remote UE traffic.

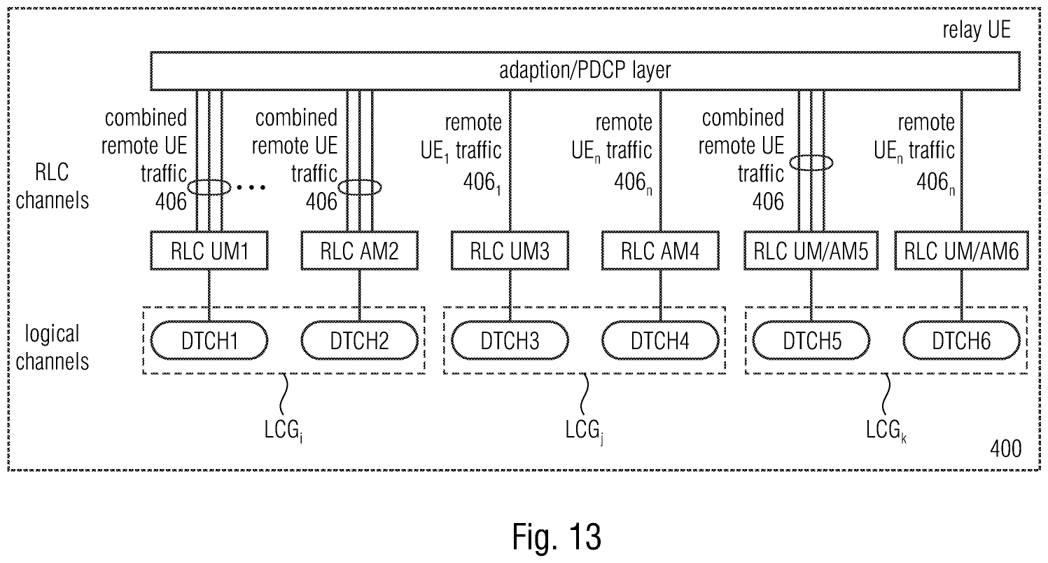

FIG. 13 illustrates yet another embodiment of the inventive approach illustrating different combinations of the set up mechanism based on the origin of the traffic. FIG. 13 illustrates the relay UE 400 that is configured with six RLC channels, RLC UM 1, RLC AM 2, RLC UM 3, RLC AM 4, RLC UM/AM 5 and RLC UM/AM 6 and logical channels DTCH 1 to DTCH 6. All of the RLC channels are associated with data originating from one or more remote UEs so that also each of the logical channels DTCH 1 to DTCH 6 is associated with remote UE data. In accordance with the depicted embodiment, the RLC channels RLC UM 1 and RLC AM 2 are associated with data from more than one remote UE, referred to in the figure as combined remote UE traffic, and, in accordance with embodiments, the associated logical channels DTCH 1 and DTCH 2 may be combined or grouped into the logical channel group LCGᵢ. The RLC channels RLC UM 3 and RLC AM 4 are both associated with data originating only from a single remote UE, and, in accordance with embodiments, the associated logical channels DTCH 3 and DTCH 4 may be grouped into the logical channel group LCGⱼ. The RLC channel RLC UM/AM 5 is associated with data from a plurality of remote UEs, and the RLC channel RLC UM/AM 6 is associated with data from a single remote UE. In accordance with embodiments, the associated logical channels DTCH 5 and DTCH 6 may be grouped into the logical channel group LCGₖ.

It is noted that FIG. 11 to FIG. 13 illustrate various embodiments for setting up the logical channels and for performing the logical channel grouping in accordance with embodiments of the present invention, and clearly, more than two logical channels may be combined into a channel group wherein each logical channel may be associated with data from a single remote UE or with data from a plurality of remote UEs.

As has been described with reference to FIG. 10, conventional procedures for setting up a logical channel or for grouping logical channels do not allow the RLC layer and the corresponding logical channels in the MAC layer to differentiate between the traffic from the relay UE and the traffic from the remote UE so that when the relay UE triggers a BSR, the RAN may also not differentiate between relay UE traffic or data and remote UE traffic or data. However, in accordance with embodiments of the present invention, when setting up the logical channels based on the origin of the traffic or data, for example in accordance with the embodiments described above with reference to FIG. 11 to FIG. 13, the protocol stack, both at the relay UE 400 and at the RAN, like at the gNB, may differentiate between relay UE data or traffic and remote UE data or traffic. For example, the logical channels associated with relaying may be assigned a certain identification, and when this identification is included in the BSR, the RAN is aware that the request for resources is for a data transmission of remote UE data or traffic.

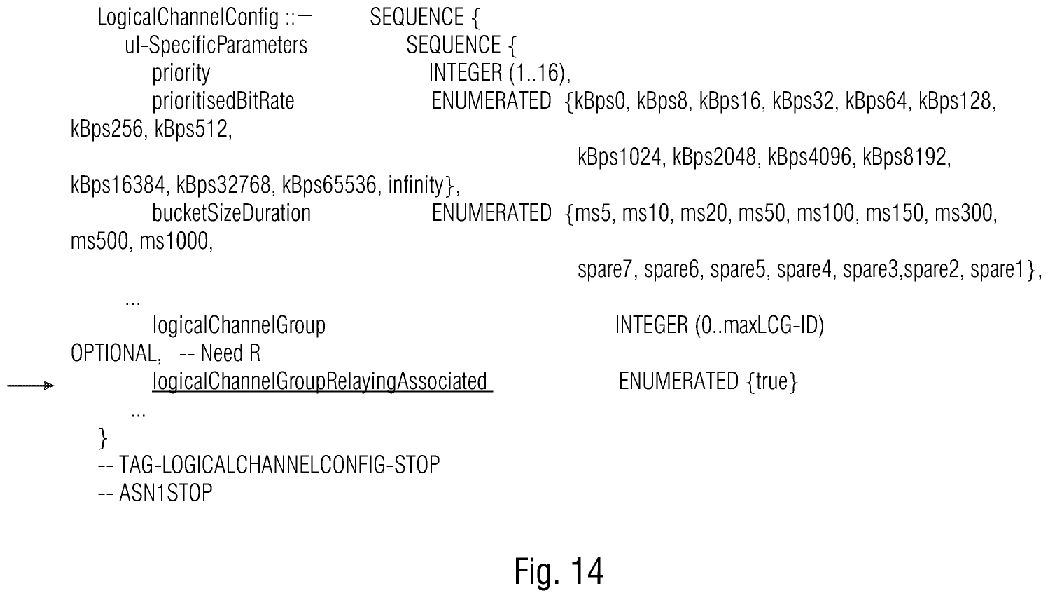

In accordance with embodiments, the relay UE may be configured with the association of logical channels and logical channel groups, for example, by an RRC configuration. An embodiment for such an RRC configuration is illustrated in FIG. 14 which illustrates an RRC configuration for a logical channel including the underlined information element, IE, indicating whether the logical channel is to carry remote UE traffic. In other words, by means of the IE illustrated in FIG. 14, the logical channel configuration may be associated with the relay UE traffic thereby making the MAC layer of the relay UE and the RAN aware that data being carried in these logical channels is remote UE traffic, thereby enabling the RAN to perform, for example, optimizations in the scheduling procedure. In accordance with further embodiments, a list of logical channels or logical channel groups associated with relaying may be provided to the UE using another RRC information element.

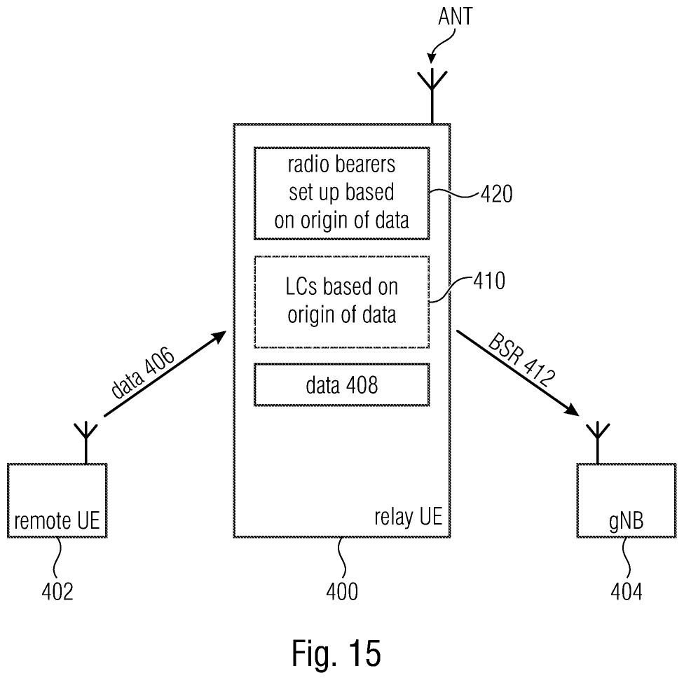

A second embodiment of the present invention is now described with reference to FIG. 15, which is similar to FIG. 9 and illustrates a relay UE that, other than in the first embodiment, allows a RAN entity, like the gNB 404, to distinguish data received from a relay UE 400 into the remote UE data 406 and into the relay data 408 on the basis of the radio bearers employed in the protocol stack. Thus, in the second embodiment, like in the first embodiment, the UE 400 is acting as a relaying entity or relay UE so as to provide functionality for supporting connectivity between the remote UE 402 and the gNB 404, and it uses radio bearers that are set up based on the origin of the data. In accordance with the second embodiment, the remote UE traffic 406 may be mapped to a radio bearer, like a data radio bearer, DRB, or a signaling radio bearer, SRB, associated with the relaying functionality because the adaption layer is above the SDAP layer. As a result of such a mapping, the remote UE traffic 406 is also visible in the PDCP layer at the RAN, for example at the gNB 404.

In accordance with embodiments of the present invention, the first and second embodiments may be combined, i.e., the relay UE 400 may employ both logical channels, LCs, set up on the origin of the data as well as radio bearers set up based on the origin of data, as is schematically illustrated in FIG. 15 by the block 410. In such embodiments, similar to the first embodiment, the setting up the logical channels based on the origin of the traffic supports differentiating between remote UE traffic 406 and relay UE traffic 408 at the MAC layer. In accordance with further embodiments, the LCs may be grouped into one or more LCGs as described above with reference to the first embodiment.

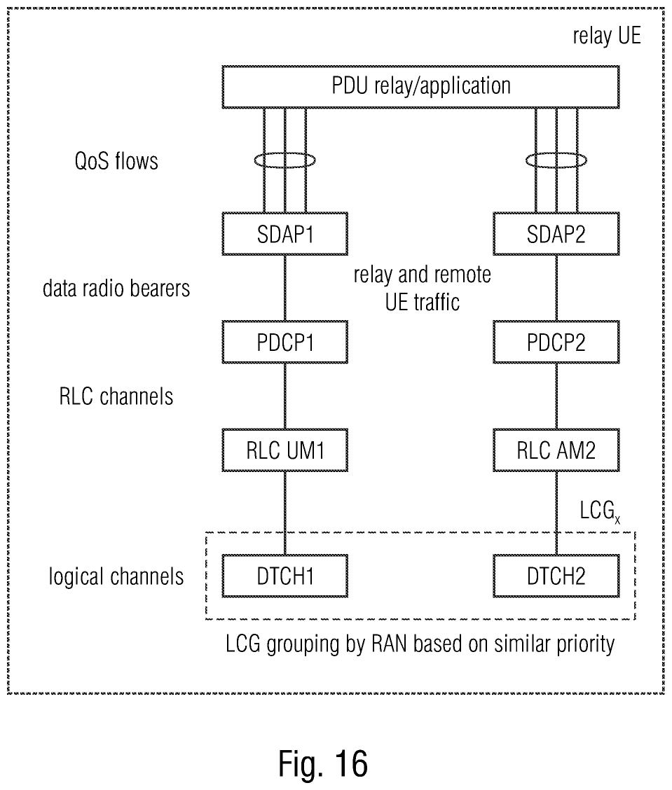

FIG. 16 illustrates a conventional relay UE including two channels including the SDAP channels SDAP 1 and SDAP 2, the PDCP channels PDCP 1 and PDCP 2, the RLC channels RLC UM 1 and RLC AM 2 and the logical channels DTCH 1 and DTCH 2. Radio bearers are associated with both remote UE data or traffic and relay UE data or traffic. The quality of service, QoS, flow includes respective packet data units, PDUs, originating at the relay 400 or at an application running on the remote UE 402 and are received at the SDAP-layer in the relay UE 400. The data radio bearers in the PDCP-layer are set up for the different channels independent of the origin of the traffic received, and the respective RLC channels are mapped to the respective logical channels DCTH 1 and DTCH 2. Thus, similar to the conventional approach described for L2 relaying with reference to FIG. 10, also in L3-relaying, the RAN entity, like the BS 404, may not differentiate the traffic between remote UE data 406 and relay UE data 408. In accordance with further conventional approaches, in addition to providing the data bearers at the PDCP-layer, the logical channels DTCH 1 and DTCH 2 may be grouped into a logical channel group LCGₓ by the RAN, for example, based on a similar priority, as described with reference to FIG. 10, and for the logical channel group resources may be requested from the RAN for the transmission by sending a BSR, either in the short format or in the long format as described above with reference to FIG. 6.

Contrary to the conventional approach described with reference to FIG. 16, in accordance with the second embodiment of the present invention, the data radio bearers are setup based on the origin of the data, so that, for example, one or more of the data radio bearers may be associated with traffic from one or more of the remote UEs, while other data radio bearers may be setup for data originating from the relay UE. In accordance with yet further embodiments, in addition to setting up the radio bearers dependent on the origin of the traffic, also the logical channel grouping approach based on the origin of the data may be applied as described above with reference to the first embodiment.

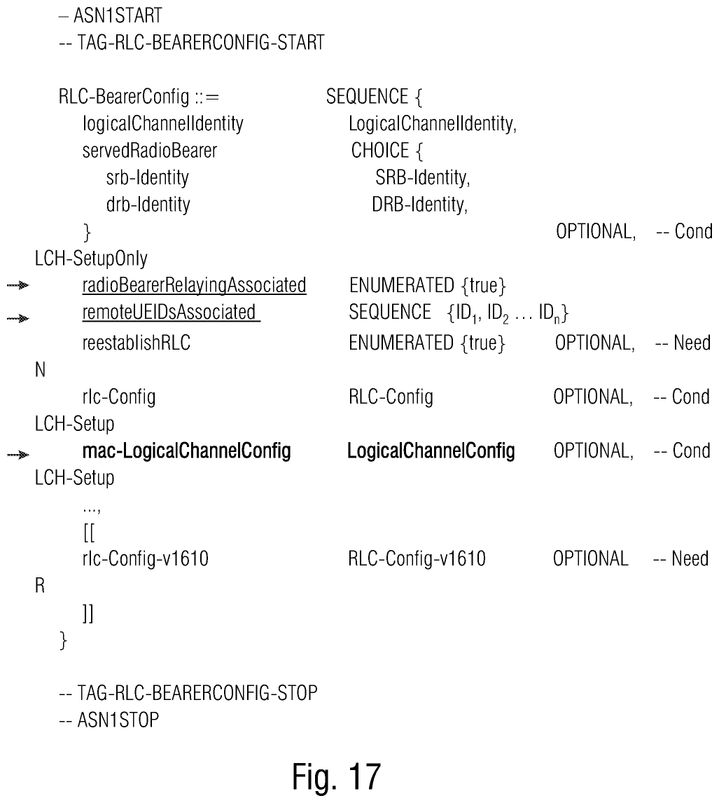

In accordance with embodiments, the relay UE 400 may be configured to so as to set up the radio bearers dependent on the origin of the data, for example, by an RRC configuration received from the RAN. An example of an RRC configuration for configuring the radio bearers at the relay UE 400 is illustrated in FIG. 17 which illustrates the configuration for the RLC radio bearer using the underlined information elements, IEs, to associate the radio bearer identity, for example, with the remote UE traffic 406. The parameter remoteUEIDsAssociated may only be applicable in case of L3 relaying. By means of the RRC configuration as illustrated in FIG. 17, the radio bearer is associated with the relaying traffic. This allows the RAN entity, like the gNB 404, to differentiate the traffic it receives from the relay UE which, in turn, allows to perform optimizations in the scheduling procedure. In accordance with further embodiments, when the relay UE 400 also implements the logical channel grouping on the basis of the origin of the data, the RRC configuration illustrated in FIG. 17 is employed together with the RRC configuration described above with reference to FIG. 14 so as to associate the radio bearer and logical channel configuration with the relaying traffic using the information elements of FIG. 14 and FIG. 17.

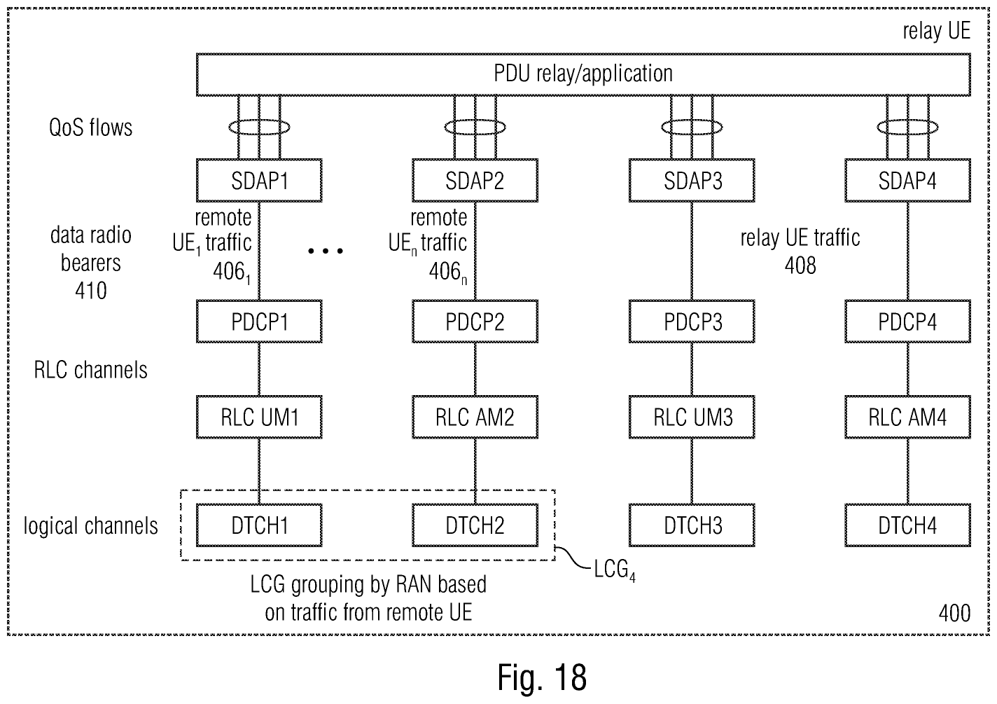

FIG. 18 illustrates an embodiment in accordance with which data radio bearers are associated with traffic from respective single remote UEs. Other than in a conventional approach, like the one illustrated in FIG. 16, in accordance with the present invention, respective data radio bearers 410 are set up in the PDCP-layer such that a first data radio bearer is associated with remote UE data or traffic 406₁ originating from a first UE, while other data radio bearers are associated with remote UE data 406ₙ from respective other single UEs, i.e. each data radio bearer is associated with traffic from one remote UE. Since the RAN entity, like the gNB 404, is aware of the radio bearer configuration, the gNB 404 may differentiate the traffic between traffic originating at the relay and traffic originating at the remote UEs. In the embodiment of FIG. 18, one or more further data radio bearers are associated with relay UE traffic 408. The traffic may be associated with respective logical channels DTCH 1 to DTCH 4, in a way as described above with reference to FIG. 11. In accordance with embodiments, the relay UE may request resources for the transmission of the traffic associated with the logical channel on a per-logical channel basis, i.e. a BSR may be transmitted for each logical channel. In accordance with further embodiments, the logical channel grouping described above with reference to the first embodiment of the present invention may also be employed, and, as is illustrated in FIG. 11, the respective logical channels may be grouped dependent on the origin of the data. The logical channels DTCH 1 and DTCH 2 may be grouped into a logical channel group LCG₄ that is associated with data originating at remote UEs. The relay UE 400 may request recourses for the data transmission on a logical channel group basis in a way as it is described above with the first embodiment. For example, the relay UE may send a BSR as explained above with reference to FIG. 11(b) and FIG. 11(c).

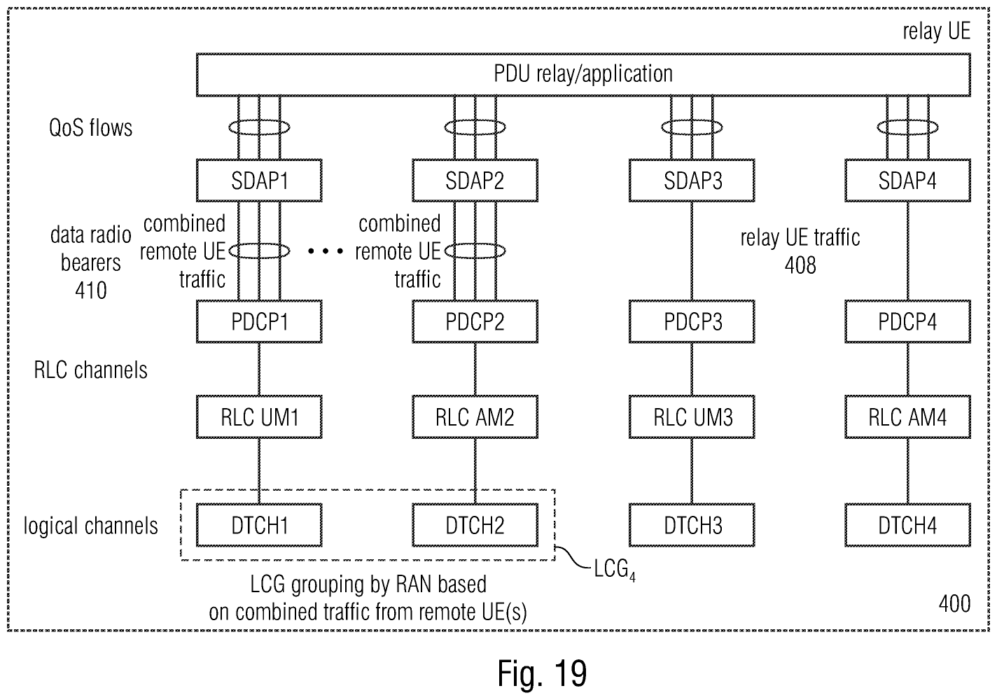

FIG. 19 illustrates a further embodiment in accordance with which the respective radio bearers 410 in the PDCP-layer are associated with combined remote UE traffic 406, meaning that each radio bearer is associated with traffic from a plurality of remote UEs. FIG. 19, like FIG. 18, illustrates four channels, and the data is received from the relay or from the application running on the remote UE. A first number of data radio bearers is provided in the PDCP-layer each of which is associated with remote UE data 406 from a plurality of remote UEs, also referred to as combined remote UE data or traffic, while a plurality of other data bearers is associated with relay UE data or traffic 408. In accordance with embodiments, the UE 400 may request resources for each logical channel DTCH 1 to DTCH 4, for example by sending a BSR on a per logical channel basis, and the RAN entity may differentiate the data on the basis of the known configuration of the data radio bearers. Also in this embodiment, the logical channel grouping based on the origin of the traffic may be employed, and the relay UE 400 may combine or group the logical channels DTCH 1 and DTCH 2 being associated with data from remote UEs into the logical channel group LCG₄ that may be indicated in a BSR, in a way as it is described above with reference to FIGS. 12(b) and 12(c).

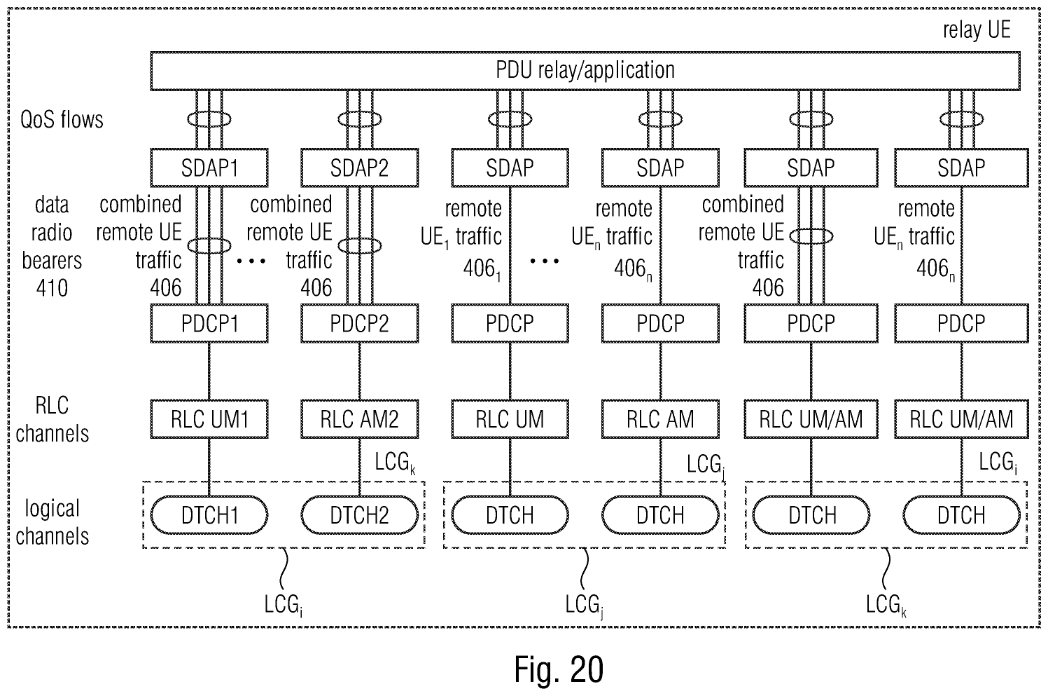

FIG. 20 illustrates embodiments of different combinations of the grouping mechanism based on the origin of the traffic, similar to FIG. 13. In accordance with the inventive approach, data radio bearers 410 may be associated with combined remote UE traffic and/or remote UE traffic and when applying in addition the logical channel grouping as described with reference to the first embodiment, different logical groups may be formed, like logical channel group LCGᵢ combining data channels DTCH 1 and DTCH 2 being associated with traffic received from a plurality of remote UEs. Another way to group the data channels is to combine into a logical channel group LCGⱼ the logical channels DTCH 3 and DTCH 4 that are associated with traffic from respective single remote UEs. Also combining the traffic from one UE and from a plurality of UEs into a channel group is possible, as is illustrated by grouping the logical channels DTCH 5 that is associated with data from a plurality of remote UEs and the logical channel DTCH 6 that is associated with data from one UE into the logical channel group LCGₖ.

In accordance with the second embodiment of the present invention, in accordance with which the data radio bearers are configured or set up on the basis of the origin of the data, when associating a data radio bearer with one UE or one group of UEs at the PDCP-layer of the relay UE 400 it is not only known that the traffic is remote UE traffic, but it is also known which remote UE or which group of remote UEs this traffic belongs to.

Thus, the RAN, like the gNB 404, may differentiate between the different types of traffic or data, namely the remote UE traffic or data and the relay UE data or traffic even at the PDCP-layer for L3-relaying, which, in accordance with further embodiments, allows the RAN to signal a delivery status report to find out about impeding data or traffic, i.e., uplink data or traffic from the one or more remote UEs. When receiving such a delivery status report, the relay UE 400 may individually poll each of the one or more remote UEs associated with a data radio bearer set up in the relay UE 400 so as to obtain information about the impeding traffic. In accordance with yet further embodiments, similar to the uplink situation, also in case of a downlink communication, i.e., when there is data or traffic from the network side towards the remote UEs, the delivery status may be employed so as to obtain from the respective remote UEs a confirmation that a certain amount of data was successfully received. In other words, following a downlink transmission of data, the gNB 400 may send the delivery status request to the relay UE 400 which polls each of the UEs associated with the data radio bearer so as to obtain from the respective remote UEs information as to whether a certain amount of data was successfully received or not, so that a feedback regarding the downlink data transmission may be provided to the gNB 404.

In accordance with further embodiments, a known identification, like a UE ID, for a remote UE 402 may be employed when configuring the remote UE with the respective data radio bearers dependent on the origin of the data so that, using the UE ID, the RAN, in case of L3 relaying, also knows which remote UE is available at the PDCP, i.e., the RAN, like the gNB 404, not only differentiates between remote UE traffic and relay UE traffic but also differentiates the remote UE traffic in such a way that the actual remote UE providing certain traffic may be identified. In such a scenario, the RAN, when sending the delivery status request mentioned above, may indicate that the report is associated with one or more particular remote UEs identified in the request, for example, using the UE ID. To use the UE ID, in accordance with embodiments, a PDU session may be established at the relay UE 400 for the remote UE 402, and the relay UE 400 sends a remote UE report message to the core network, for example, to the session management function, SMF, for the PDU session. The remote UE report may include a remote user ID and remote UE information. The remote user ID is an identity of the remote UE user that is successfully connected to the relay UE, and the remote UE information is used to assist identifying the remote UE in the core network, like the SGC. For example, in case of an internet protocol, IP, PDU session type, the remote UE information is remote UE IP information. On the other hand, for an Ethernet PDU session type, the remote UE information is the remote UE MAC address which is detected by the UE-to-network relay 400. In case of an unstructured PDU session type, the remote UE information includes the PDU session ID. The SMF stores the remote UE IDs and, if available, the remote UE information, for example in the ProSe 5G UE-to-network relay context for this PDU session associated with the relay.

In accordance with embodiments, the SMF may send the stored UE ID and, if available, the stored UE information to the RAN, like the gNB 404, so that the RAN is aware which remote UEs are served by a particular PDU session. In accordance with other embodiments, the UE ID may be available at the relay UE 400, and the UE relay 400 may send the UE ID and, if available, the UE information to the RAN, like the gNB 404. Thus, the RAN is aware of the combination of UE ID/UE information and QoS profile/link ID/service type. Based on this information provided by the core network to the RAN, the RAN may associate the DRB with a specific UE or with a combined set of remote UEs or a group of remote UEs.

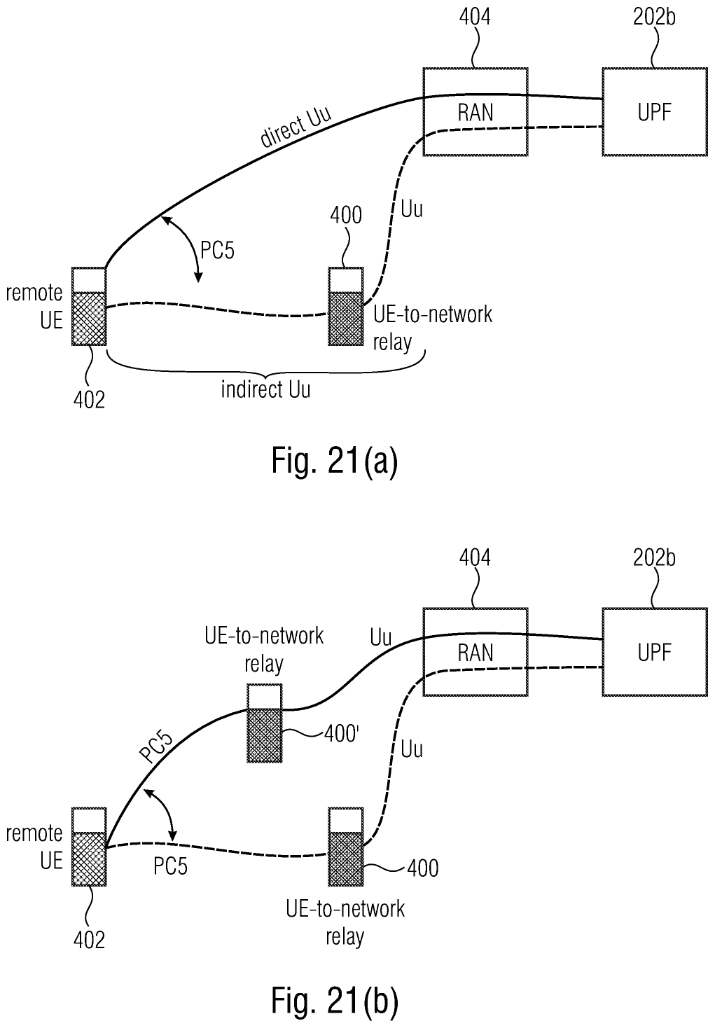

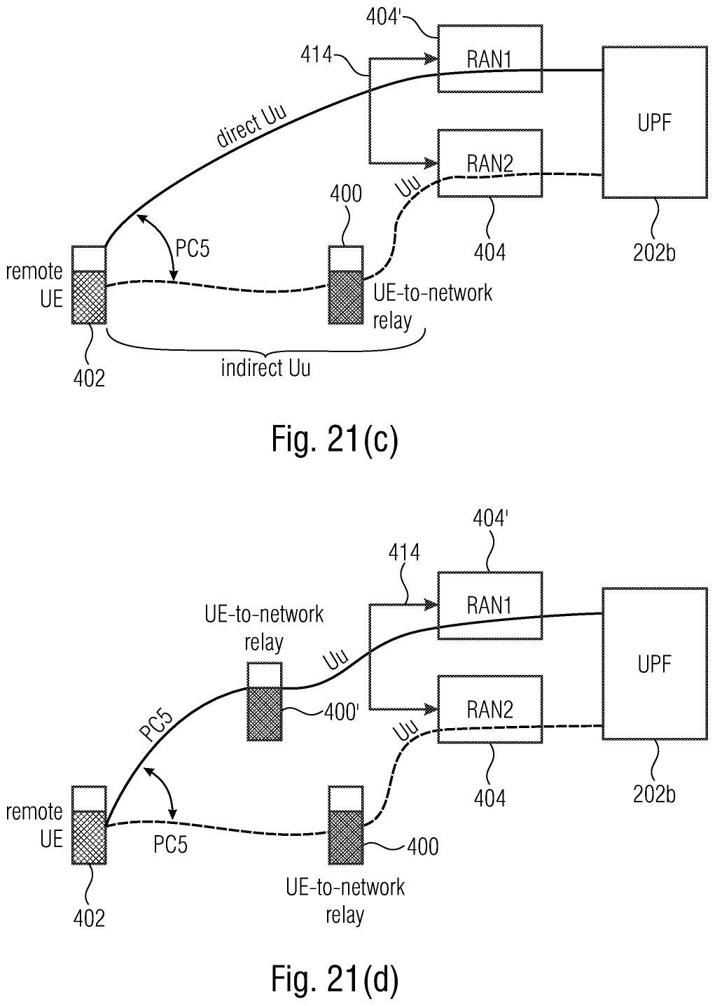

In accordance with the second embodiment of the present invention, the RAN is aware of the remote UE traffic at the PDCP-layer. In other words, the awareness of the remote UE traffic at the PDCP-layer of the RAN may be based on the one or more data radio bearers associated with one or more specific remote UEs, or on one or more DRBs associated with combined remote UE traffic, i.e. traffic from a plurality of remote UEs. In accordance with further embodiments, this information is used during a path switching procedure so as to enable service continuity on an excess stratum level. FIG. 21 illustrates embodiments for maintaining service continuity during path switching, and FIG. 21(a) and FIG. 21(b) illustrate an Intra-RAN path switching, while FIGS. 14(c) and 14(d) illustrate an Inter-RAN path switching.

FIG. 21(a) illustrates a remote UE 402 that is to be connected to a core network entity 202b, like the user plane function, UPF. If possible, a direct Uu connection is established, however, when such a direct Uu connection is not possible, an indirect Uu connection via the UE-to-network relay 400 is established so that the remote UE is connected to the relay UE via the PCFS interface, while the relay UE is connected via the Uu interface to the RAN 404 and to the core network 202b. In case a connection between the relay UE 400 and the remote UE 402 and/or the RAN 404 is no longer reliable or needs to be changed for other reasons, an Intra-RAN path switching may be initiated for connecting the remote UE 402 to the RAN 404 via a different relay UE 404′. As is illustrated in FIG. 21(b), instead of relay UE 400 a new relay UE 400′ may be selected having, for example, better channel conditions for connecting remote UE 402 via the RAN 404 to the UPF 202b.

FIG. 21(c) illustrates a scenario in accordance with which the remote UE 402 is to be connected to the UPF 202b and a direct connection via the direct Uu interface via a first RAN 404a may not be sufficient for fulfilling certain requirements for the communication between the remote UE 402 and the UPF 202b so that an indirect connection via the relay UE 400 is employed. In the scenario of FIG. 21 (c), the relay UE 400 connects to the UPF 202b via a different RAN 404b. In case a link between the remote UE 402 and the UPF 202b via the relay UE 400 need to be changed, a new relay UE 400′, as illustrated in FIG. 21(d), may be selected, and the new relay UE 400′ connects to the UPF 202b via the first RAN 404a so that when changing from relay UE 400 to relay UE 400′ an Inter-RAN path switching occurs.

Thus, when the remote UE 402 reselects the relay UE to be used, namely to change from one UE to a network relay 400 to another relay 400′, the first relay UE 400 forwards PDCP information, for example the PDCP sequence number, SN, or other information, like a SN Status transfer and End marker, along with the remote UE ID that the relay UE 400 served to the RAN 404 such that the RAN may seamlessly continue to provide the service without interruption based on the received information. For example, the PDCP information from relay 400 may indicate to the RAN which packets it is to expect to receive or send via the new relay 400′.

In the case of an intra-RAN path switch, there are two scenarios:

(a) The remote UE 402 is connected via an indirect Uu path through the relay 400 to the RAN 404 (see FIG. 21(a)), then decides to reselect to a direct Uu path to the same 404, or the other way round, i.e., the remote UE 402 may switch from a direct Uu path to an indirect Uu path.

(b) The remote UE 402 is connected via an indirect Uu path through the relay 400 to the RAN 404 (see FIG. 21(b)), then decides to reselect to another indirect path via the relay 400′ to the same RAN 404, or the other way round, i.e., the remote UE 402 may switch from an indirect Uu via the relay 400′ to an indirect Uu via the relay 400.

In both scenarios (a) and (b) above, for the case of an intra-RAN path switch, the relay 400 forwards the PDCP information to the RAN 404. The RAN 404 then performs the necessary modifications to provide service continuity, i.e., guarantee no packet loss in the access stratum (AS) layer.

In the case of inter-RAN path switch, there are also two scenarios

(a) The remote UE 402 is connected via an indirect Uu path through the relay 400 to the RAN 404 (see FIG. 21(c)), then decides to reselect to a direct Uu path to a different RAN 404′.

(b) The remote UE 402 is connected via an indirect Uu path through the relay 400 to the RAN 404 (see FIG. 21(d)), then decides to reselect to another indirect Uu path via the relay 400′ to a different RAN 404′, or the other way round, i.e., the remote UE 402 may switch from an indirect Uu via 400′ to an indirect Uu path via the relay 400.

In both scenarios (a) and (b) above, for the case of an inter-RAN path switch, the relay UE 400 sends the corresponding PDCP information to the RAN 404 which then forwards this information to RAN 404′, e.g., via the Xn interface 414. The RAN 404′ then performs the necessary modifications to guarantee no packet loss at the AS layer.

Further embodiments of the present invention allow for a dynamic traffic handling. In conventional approaches, the RAN may configure each of the logical channels with a priority, which is used by a UE in the LCP procedure to allocate resources to the logical channel, i.e., allocate resources to the different logical channels based on priority. For example, each priority is associated with a certain number indicating the level of priority, and higher numbers may indicate a lower priority. In addition, conventional approaches also suggest the grouping of the logical channels to be based on the priority values, i.e., channels having similar priorities may be grouped together. Also when considering the inventive approach, when grouping logical channels into groups for remote UE traffic and for relay UE traffic, each group of logical channels may have different priority values. For example, a relay UE traffic group may include traffic or data associated with the priorities (1, 4), whereas a remote UE traffic group may include traffic associated with priorities (1, 2 and 5). In conventional approaches, the LCP performs the scheduling of the logical channels based on priority, i.e., initially the LCP schedules channels with priority 1, then channels with priorities 2, 4 and 5. However, in accordance with the inventive approach, the RAN now has an additional degree of freedom in terms of differentiating between remote UE traffic or data and relay UE traffic or data that may be employed for the purposes of load balancing or optimization. For example, the RAN may configure the LCP procedure in such a way that, initially, remote UE traffic is scheduled so that the LCP procedure is modified in such a way that, initially, scheduling is performed for the remote UE traffic by scheduling the traffic having associated the priorities (1, 4), followed by the scheduling for the relay UE traffic having associated the priorities (1, 2, 5). In accordance with other embodiments, the LCP procedure may perform the scheduling the other way round, i.e., initially schedule the relay UE traffic followed by the scheduling of the remote UE traffic.

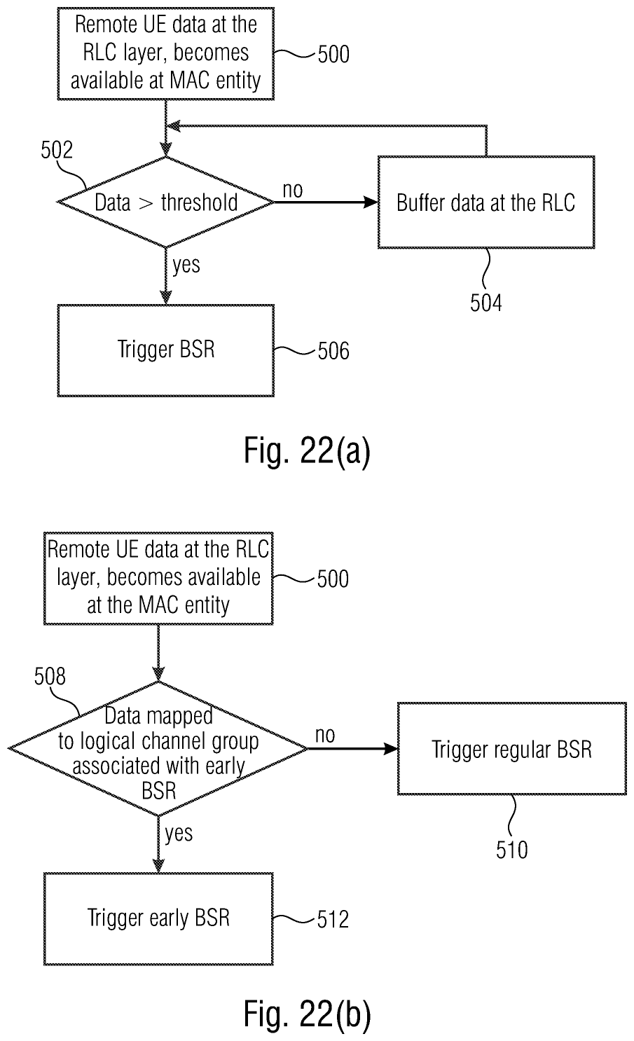

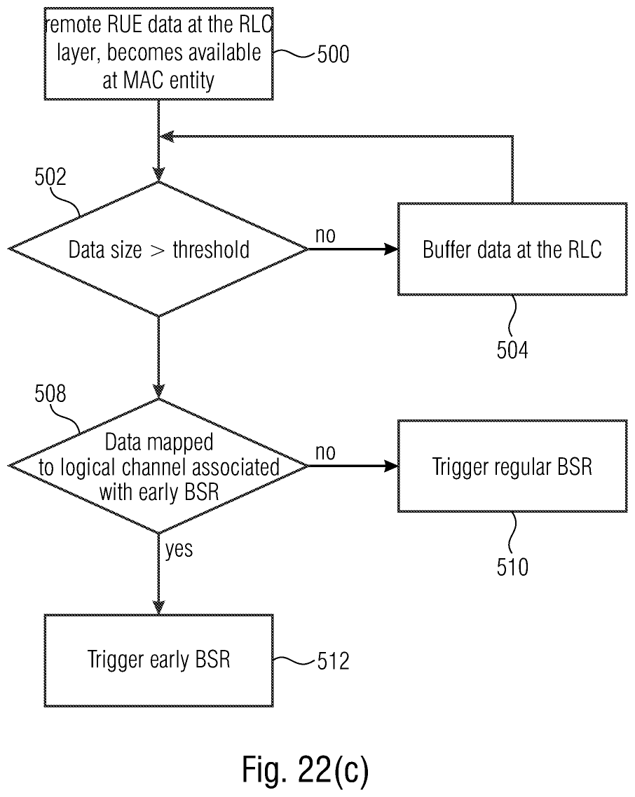

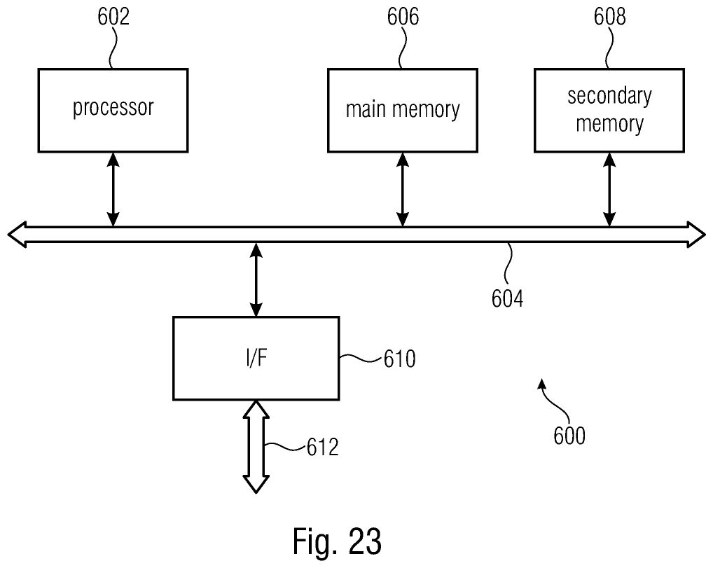

As described above with reference to the first and second embodiments of the present invention, the remote UE 400 may request resources for a transmission to the RAN using the buffer status report BSR. Embodiments of the present invention are now described which concern a new trigger mechanism for the BSR. FIG. 22 shows flowcharts of a trigger criterion for the BSR in accordance with embodiments of the present invention.

In FIG. 22(a) illustrates a flowchart for the trigger criterion for the BSR in accordance with embodiments of the present invention. At 500 remote UE data at the RLC layer becomes available at the MAC layer or MAC entity. The remote UE data may be either remote UE data from a single remote UE or it may be combined remote UE data, i.e., data or traffic originating from a plurality of remote UEs. At 502, it is determined whether the amount of data available at the MAC entity exceeds or reaches or certain threshold. In case the amount of data is below this threshold, the data is buffered in a transmission buffer that may be located at the RLC-layer or at the PDCP-layer or at the adaption layer. Once the amount of data available at the MAC entity exceeds the threshold, the remote UE 400 triggers the BSR as indicated at 506. Thus, in accordance with the embodiment illustrated in FIG. 22(a), the BSR triggers 506 when the amount of data available at the RLC channel exceeds a certain threshold that may be configured by the RAN. This implicitly means that in a certain scenario, for example in case of a combined remote UE traffic, the relay UE 400 initiates a transmission to the RAN only when all of the remote UE traffic is available, or in case the traffic from some or all of the remote UEs exceeds the size of the transmission buffer.

FIG. 22(b) illustrates a further flowchart for the trigger criterion for the BSR in accordance with further embodiments of the present invention. Similar to FIG. 22(a), at 500 remote data at the RLC-layer becomes available at the MAC entity. At 500a, it is determined whether the available data is to be mapped to a logical channel associated with an early BSR. In case this is not true, a regular BSR procedure is triggered, as is indicated at 510, otherwise, in case the data is mapped to a logical channel associated with early BSR, an early BSR is triggered as is indicated at 512. In accordance with the embodiment of FIG. 22(b), data packets of remote UEs having special requirements may be mapped to a particular logical channel. For example, data or traffic having low delay requirements may be mapped to a particular logical channel, while data or traffic associated with high robustness constraints are mapped to a different logical channel. The relay UE 400 may treat the respective data or traffic accordingly, for example by associating logical channel being associated with the above-mentioned special requirements are always associated with the early BSR mechanism so that, in case data is available in these logical channel, an early BSR mechanism is triggered. The RAN may configure the relay UE with those logical channel that are associated with an early BSR mechanism.

FIG. 22(c) illustrates another embodiment which combines the embodiments of FIG. 22(a) and FIG. 22(b). Initially, a remote UE data at the RLC-layer becomes available at the MAC entity, as indicated at 500, it is determined, at 502, whether the amount of data exceeds the threshold or not. In case the threshold is not exceeded, the data is buffered, as indicated at 504. In case the amount of data exceeds the threshold, it is determined at 508 whether the data is mapped to a logical channel group associated with an early BSR so that, dependent on the result, a regular BSR 510 or an early BSR 512 may be triggered.

### General

Although the respective aspects and embodiments of the inventive approach have been described separately, it is noted that each of the aspects/embodiments may be implemented independent from the other, or some or all of the aspects/embodiments may be combined.

In the above embodiments, the inventive concept has been described with reference to an uplink, UL, scenario for transmitting data originating at a remote UE or at the relay UE to the RAN, i.e., a transmitting entity is a remote UE and a receiving entity is a RAN entity, like a gNB. In accordance with further embodiments, in the UL scenario data may originate at a further relay UE rather than at a remote UE so that a transmitting entity may also be a further relay UE. Likewise, the transmission may be towards a further relay UE, rather than to a RAN entity, so that a receiving entity is also a relay UE.

The present invention is not limited to the above UL scenario but is equally applicable to a downlink, DL, scenario for transmitting data originating at the RAN or at the relay UE to a remote UE, i.e., a transmitting entity is a RAN entity, like a gNB and a receiving entity is a remote UE. In accordance with further embodiments, in the DL scenario data may originate at a further relay UE rather than at the RAN so that a transmitting entity may also be a further relay UE. Likewise, the transmission may be towards a further relay UE, rather than to a remote UE, so that a receiving entity is also a relay UE.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 28 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network,
wherein the UE is to act as a relaying entity so as to provide functionality to support connectivity between one or more transmitting entities and one or more receiving entities of the wireless communication network,
wherein the UE is to set up one or more logical channels and a plurality of radio bearers for a transmission of data from the UE to the one or more receiving entities based on the origin of the data,
wherein
one or more first signal bearers associated with one or more transmitting entities are to serve traffic classified to fulfill a first requirement, like a Guaranteed Bit Rate, GBR, and
one or more second signal bearers associated with one or more transmitting entities are to serve traffic classified to fulfill a second requirement, like a non-Guaranteed Bit Rate, non-GBR, and
wherein, when data is available at one or more of the logical channels, the UE is to request resources for the transmission from the UE to the one or more receiving entities, e.g., using a buffer status report, BSR, that may be triggered per logical channel or per LCG.

2. The user device, UE, of claim 1, wherein the UE is to setup a plurality of logical channels for the transmission of data based on the origin of the data, and to group the plurality of logical channels into one or more groups of logical channels, LCGs.

3. The user device, UE, of claim 1 wherein the UE is to associate the at least one logical channel with data originating at the one or more transmitting entities.

4. The user device, UE, of claim 1, wherein the UE is to set up at least one further logical channel, and to associate at least one further logical channel with data originating at the UE.

5. The user device, UE, of claim 4, wherein the UE is to setup a plurality of further logical channels associated with data originating at the UE, and to group the plurality of further logical channels into one or more groups of logical channels, LCGs.

6. The user device, UE, of claim 1, wherein
the UE is configured or preconfigured with certain logical channels of the plurality of logical channels and with certain radio bearers, like SRBs and/or DRBs, of a plurality of radio bearers that are associated with relaying data from the UE to the one or more receiving entities, and
the UE is to map data originating at the one or more transmitting entities to the certain logical channels and to the certain radio bearers.

7. (canceled)

8. The user device, UE, of claim 1, wherein the UE is to set up the plurality of radio bearers such that one or more of the radio bearers, like SRBs and/or DRBs, are associated with data from the one or more transmitting entities.

9. The user device, UE, of claim 8, wherein the UE is to set up the plurality of radio bearers such that one or more others of the radio bearers are associated with data originating at the UE.

10-12. (canceled)

13. The user device, UE, of claim 1, wherein the UE is to associate a radio bearer with a specific UE or with a combined set of UEs using an identification received via a receiving entity, like a RAN entity.

14. The user device, UE of claim 13, wherein responsive to receiving the identifications, the UE is to associate a particular PDU session supported by the radio bearer with the corresponding Quality of Service, QoS, profile or link ID or service type for the one or more transmitting entities.

15. (canceled)

16. The user device, UE, of claim 1 wherein data originating at the one or more transmitting entities comprises
data originating at one of the transmitting entities, or
data originating at a plurality of the transmitting entities.

17. (canceled)

18. The user device, UE, of claim 1, wherein the UE is
configured with the association of the one or more logical channels and/or the one or more LCGs and/or the radio bearers with the origin of the data, e.g., using an RRC configuration explicitly indicating which LCG and/or radio bearer is associated with data originating at the transmitting entities, and which LCG and/or radio bearer is not associated with data originating at the transmitting entities, or
preconfigured, for example specified in the standards or embedded into the UE, with the association of the one or more logical channels and/or the one or more LCGs and/or the radio bearers with the origin of the data, e.g., such that one or more LCGs and/or one or more radio bearers are associated with data originating at the transmitting entities responsive to activating the relaying functionality at the UE.

19. The user device, UE, of claim 1, wherein the UE is to signal, e.g., using RRC signaling, which logical channel and/or which LCG and/or radio bearer is associated with data originating at the transmitting entities, and which LCG or radio bearer is not associated with data originating at the transmitting entities.

20-21. (canceled)

22. The user device, UE, of claim 1, wherein the UE is to trigger a BSR responsive to an amount of data originating at the transmitting entities reaching or exceeding a threshold, like a size or a certain percentage of the size of a transmission buffer of the UE.

23-24. (canceled)

25. The user device, UE, of claim 1, wherein the UE to map data originating at the transmitting entities and being associated with one or more special requirements, like low latency and/or high reliability, to a logical channel and/or to a LCG and/or to a radio bearer associated with the one or more special requirements.

26. The user device, UE, of claim 1, wherein the UE is configured or preconfigured with
a priority for each of the logical channels and/or radio bearers, and
a prioritization procedure, like a logical channel prioritization, LCP, procedure, to cause the UE to
initially perform scheduling resources for data originating at the one or more transmitting UEs, followed by scheduling resources for data originating at the relaying entity, or
initially perform scheduling resources for data originating at the relaying entity, followed by scheduling resources for data originating at the one or more transmitting UEs.

27. The user device, UE, of claim 1, wherein
the data comprises user-plane, UP, data, and the set up logical channels comprise dedicated traffic channels, DTCHs, and/or
the data comprises control-plane, CP, data, and the set up logical channels comprise dedicated control channels, DCCHs, common control channels, CCCHs. 30 28. (Original) The user device, UE, of claim 1, wherein the transmitting entity and the receiving entity comprises any one of a user device, UE, a relaying entity and a network entity, like a radio access network, RAN, entity.

29-38. (canceled)

39. A wireless communication network, comprising
one or more relaying entities comprising a user device, UE, of claim 1,
one or more radio access network, RAN, entities for a wireless communication network,
wherein the RAN entity is to communicate with one or more user devices, UEs, of the wireless communication network via a-the relaying entity providing functionality to support connectivity between the RAN entity and the one or more UEs, and
one or more remote user devices, UEs, the one or more remote UEs to communicate with a RAN entity via a relaying entity.

40-43. (canceled)

44. A method for operating a user device, UE, for a wireless communication network, the method comprising:
providing, by the UE, functionality to support connectivity between one or more transmitting entities and one or more receiving entities of the wireless communication network, and
setting up one or more logical channels and a plurality of radio bearers for a transmission of data from the UE to the one or more receiving entities based on the origin of the data,
wherein
one or more first signal bearers associated with one or more transmitting entities are to serve traffic classified to fulfill a first requirement, like a Guaranteed Bit Rate, GBR, and
one or more second signal bearers associated with one or more transmitting entities are to serve traffic classified to fulfill a second requirement, like a non-Guaranteed Bit Rate, non-GBR, and
wherein, when data is available at one or more of the logical channels, requesting, by the UE, resources for the transmission from the UE to the one or more receiving entities, e.g., using a buffer status report, BSR, that may be triggered per logical channel or per LCG.

45-47. (canceled)
